(19) United States
(12) Patent Application Publication
(10) Pub. No.: US 2023/0205734 A1
(43) Pub. Date: Jun. 29, 2023

(54) SYSTEMS AND METHODS FOR FILE IDENTIFICATION

(71) Applicant: Citrix Systems, Inc., Fort Lauderdale, FL (US)

(72) Inventors: Wenshuang Zhang, Nanjing (CN); Xuan Liu, Nanjing (CN); Tingqiang Sun, Nanjing (CN); Jiang Chang, Nanjing (CN)

(21) Appl. No.: 17/569,654

(22) Filed: Jan. 6, 2022

Related U.S. Application Data
(63) Continuation of application No. PCT/CN2021/141427, filed on Dec. 27, 2021.

(51) Int. Cl. G06F 16/14; G06F 16/16; G06F 16/176; G06K 9/62

(52) U.S. Cl. CPC G06F 16/148; G06F 16/16; G06F 16/156; G06F 16/176; G06K 9/6215

(57) ABSTRACT

A computing system may determine, based at least in part on communications exchanged via one or more applications, at least a first keyword indicative of a first subject matter. The computing system may determine that at least a first file includes content corresponding to the first keyword, the first file being stored in a storage medium and accessible by a client device, and cause a user interface, at the client device, to present at least a first user interface element indicative of the first file, where the first user interface element being selectable to enable retrieval of the first file from the storage medium.

### CROSS-REFERENCE TO RELATED APPLICATIONS

This application is a continuation of and claims the benefit under 35 U.S.C. § 120 and 35 U.S.C. § 365(c) to International Application PCT/CN2021/141427, entitled SYSTEMS AND METHODS FOR FILE IDENTIFICATION, with an international filing date of Dec. 27, 2021, the entire contents of which are incorporated herein by reference for all purposes.

### BACKGROUND

Various file sharing systems have been developed that allow users to share files or other data. ShareFile®, offered by Citrix Systems, Inc., of Fort Lauderdale, FL, is one example of such a file sharing system.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method performed by computing system involves determining, based at least in part on communications exchanged via one or more applications, at least a first keyword indicative of a first subject matter, determining that at least a first file includes content corresponding to the first keyword, the first file being stored in a storage medium and accessible by a client device, and causing, based at least in part on the first file including content corresponding to the first keyword, a user interface, at the client device, to present at least a first user interface element indicative of the first file, the first user interface element being selectable to enable retrieval of the first file from the storage medium.

In some disclosed embodiments, a system comprise at least one processor, and at least one computer-readable medium encoded with instruction which, when executed by the at least one processor, cause the system to determine, based at least in part on communications exchanged via one or more applications, at least a first keyword indicative of a first subject matter, determine that at least a first file includes content corresponding to the first keyword, the first file being stored in a storage medium and accessible by a client device, and cause, based at least in part on the first file including content corresponding to the first keyword, a user interface, at the client device, to present at least a first user interface element indicative of the first file, the first user interface element being selectable to enable retrieval of the first file from the storage medium.

In some disclosed embodiments, at least one non-transitory computer-readable medium may be encoded with instructions which, when executed by at least one processor included in a computing system, cause the computing system to determine, based at least in part on communications exchanged via one or more applications, at least a first keyword indicative of a first subject matter, determine that at least a first file includes content corresponding to the first keyword, the first file being stored in a storage medium and accessible by a client device, and cause, based at least in part on the first file including content corresponding to the first keyword, a user interface, at the client device, to present at least a first user interface element indicative of the first file, the first user interface element being selectable to enable retrieval of the first file from the storage medium.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a diagram of how a system may identify files in accordance with some embodiments of the present disclosure;

FIG. 1B shows an example user interface screen displaying keywords and relevant files;

FIG. 1C shows an example user interface screen displaying a notification about a selected file;

FIG. 2 is a diagram of a network environment in which some embodiments of the present disclosure may be deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a diagram illustrating how a network computing environment like one shown in FIG. 2 may be configured to allow clients access to an example embodiment of a file sharing system;

FIG. 5B is a diagram illustrating certain operations that may be performed by the file sharing system shown in FIG. 5A in accordance with some embodiments;

FIG. 5C is a diagram illustrating additional operations that may be performed by the file sharing system shown in FIG. 5A in accordance with some embodiments;

FIG. 6A is a block diagram of an example system in which resource management services may manage and streamline access by clients to resource feeds (via one or more gateway services) and/or software-as-a-service (SaaS) applications;

FIG. 6B is a block diagram showing an example implementation of the system shown in FIG. 6A in which various resource management services as well as a gateway service are located within a cloud computing environment;

FIG. 6C is a block diagram similar to that shown in FIG. 6B but in which the available resources are represented by a single box labeled “systems of record,” and further in which several different services are included among the resource management services;

FIG. 6D shows how a display screen may appear when an intelligent activity feed feature of a multi-resource management system, such as that shown in FIG. 6C, is employed;

FIG. 7 is a diagram illustrating an example system for identifying files in accordance with some embodiments;

FIG. 8 shows an example routine that may be performed by a resource access application at the client device shown in FIG. 7 to request display of files in accordance with some embodiments;

FIG. 9 shows a first example routine that may be performed by the file recommendation service shown in FIG. 7 to determine keywords in accordance with some embodiments;

FIG. 10 shows a second example routine that may be performed by the file recommendation service shown in FIG. 7 to determine file content data in accordance with some embodiments;

FIG. 11 shows a third example routine that may be performed by the file recommendation service shown in FIG. 7 to determine files corresponding to keywords in accordance with some embodiments;

FIG. 12 shows a fourth example routine that may be performed by the file recommendation service shown in FIG. 7 to notify the user that a selected file in accordance with some embodiments;

FIG. 13 shows a fifth example routine that may be performed by the file recommendation service shown in FIG. 7 to identify potential recipients for a file in accordance with some embodiments; and

FIG. 14 shows an example user interface screen that displays potential recipients for a file.

### DETAILED DESCRIPTION

For purposes of reading the description of the various embodiments below, the following descriptions of the sections of the specification and their respective contents may be helpful:
Section A provides an introduction to example embodiments of a system for identifying files;
Section B describes a network environment which may be useful for practicing embodiments described herein;
Section C describes a computing system which may be useful for practicing embodiments described herein.
Section D describes embodiments of systems and methods for delivering shared resources using a cloud computing environment;
Section E describes example embodiments of systems for providing file sharing over networks;
Section F describes embodiments of systems and methods for managing and streamlining access by clients to a variety of resources
Section G provides a more detailed description of example embodiments of the system for identifying files introduced in Section A; and
Section H describes example implementations of methods, systems/devices, and computer-readable media in accordance with the present disclosure.

### A. Introduction to Illustrative Embodiments of a System for Identifying Files

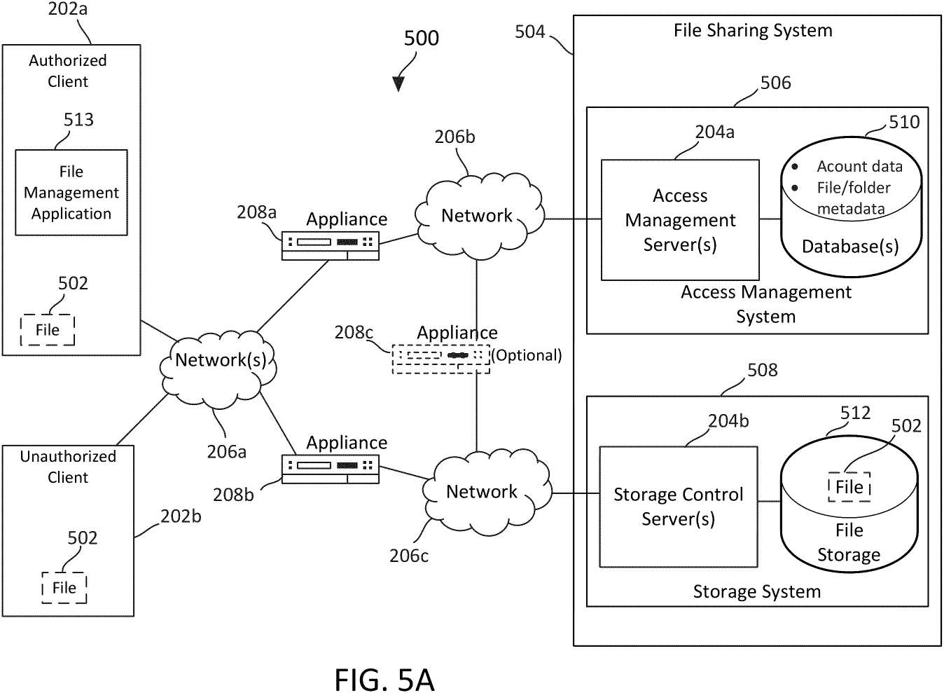

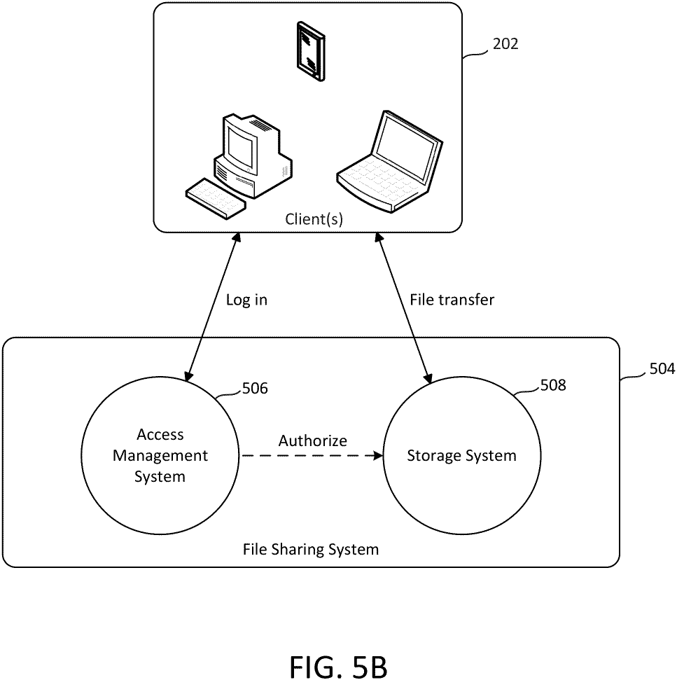

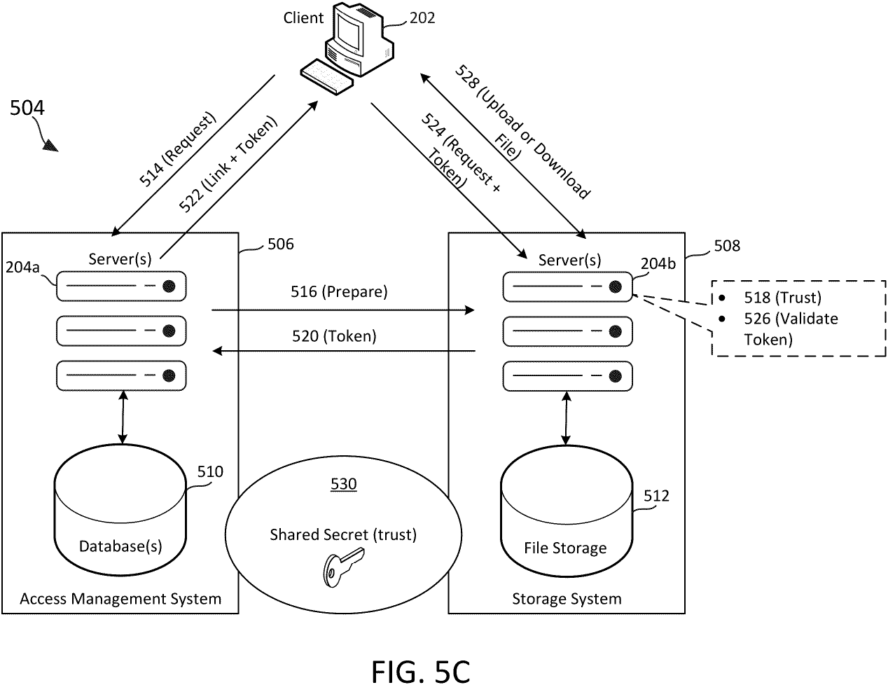

Various file sharing systems have been developed that allow users to share files with other users over a network. An example of such a file sharing system 504 is described below (in Section E) in connection with FIGS. 5A-C. As explained in Section E, in some implementations, one client device 202 may upload a file 502 (shown in FIG. 5A) to a central repository of the file sharing system 504, such as storage medium(s) 512 shown in FIGS. 5A-C, and another client device 202 may then download a copy of that file 502 from the same repository. As Section E also describes, in some implementations, an access management system 506 may regulate the circumstances in which files 502 may be uploaded and/or downloaded to/from a storage system 508 (including the storage medium 512(s)) by various client devices 202.

A user may have access to a large number of files in the file sharing system 504, and when sharing files with other users, it may be difficult for the user to quickly or correctly select a desired file for sharing. For example, some filenames may not be descriptive of the file content, and the user may have to open the file to determine whether it is the desired file. As another example, the user may have to scroll through a large list of files to locate the desired file. A sorting function, offered by some systems, may not be helpful, as such storing functions are limited to sorting files alphabetically based on filenames, sorting files based on a related date (e.g., date the file is created, date the file is modified, date the file is shared, etc.), sorting files based on file size, or sorting files based on file type. However, such sorting may not help the user in quickly identifying the desired file. The inventors of the present disclosure have recognized and appreciated that users usually want to share files that relate to the current subject matter they are working on. The present disclosure relates to systems and methods for identifying files related to a subject matter(s).

Some embodiments use information from various applications that a user uses (e.g., applications to perform work or communicate). Such applications can be an email application, a collaboration tool, a messaging application, a project management application, or the like. Using the information, keywords indicative of a subject matter(s) can be extracted. The extracted keywords may be used to identify files related to that subject matter. The files may be presented to a user in response to the user requesting to view such files.

In a non-limiting example, in the recent time (e.g., past two weeks), a user and colleagues may have been working on a project called “Project A”, and the user may have discussed the project with the colleagues via various applications, such as Microsoft Outlook, Slack, Microsoft Teams, JIRA, etc. Based on the user’s interactions with the various applications, a system of the present disclosure may determine a keyword as “Project A.” The system may analyze file contents for files that the user is authorized to access, and identify files that correspond to the keyword “Project A.” The files corresponding to the keyword “Project A” may be displayed, so that the user can easily and quickly identify a file for sharing, viewing, or opening.

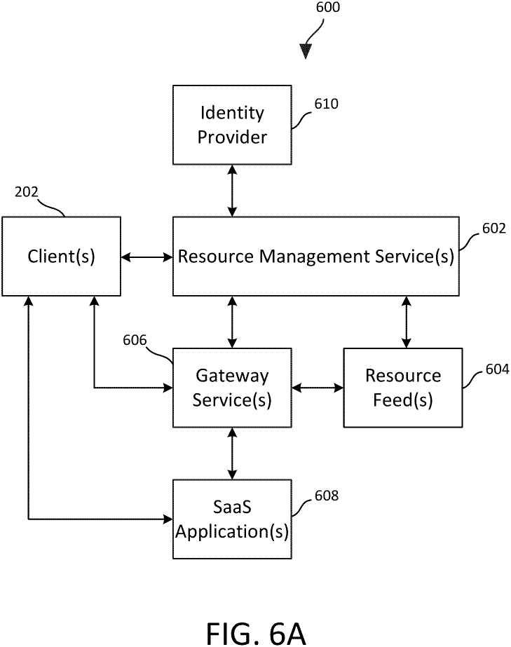

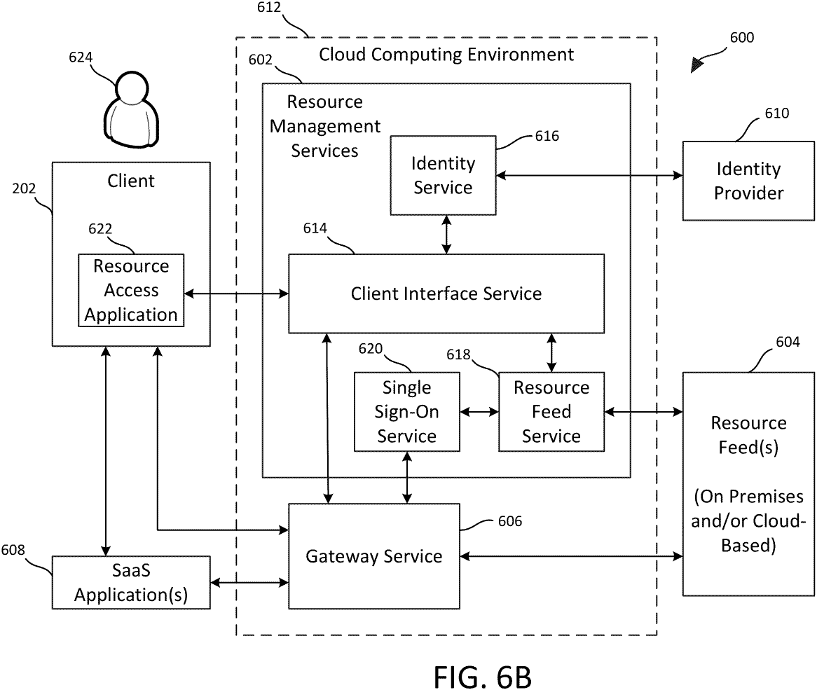

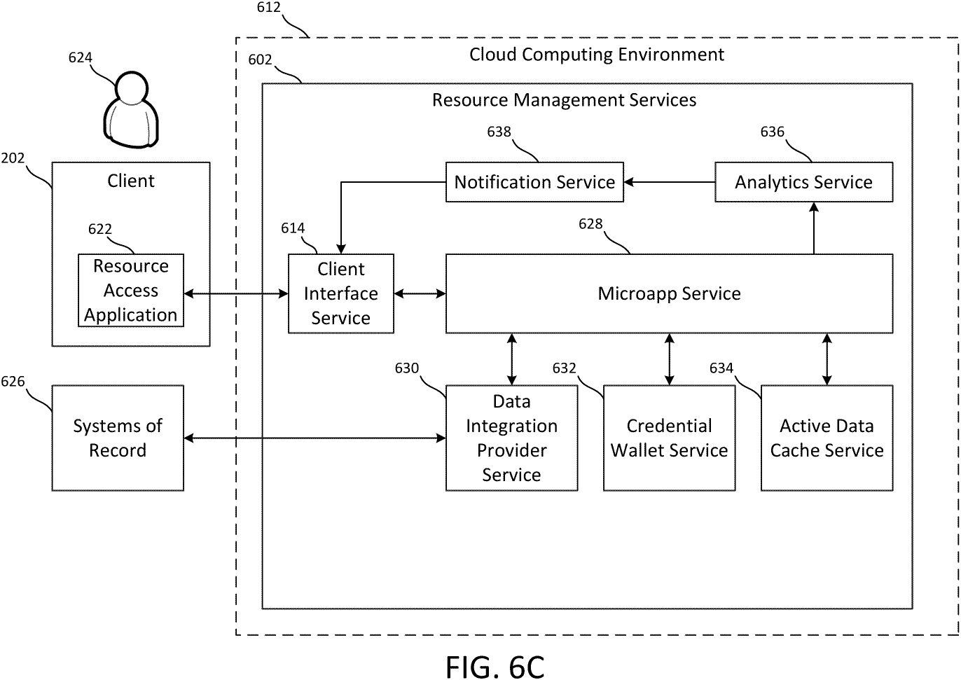

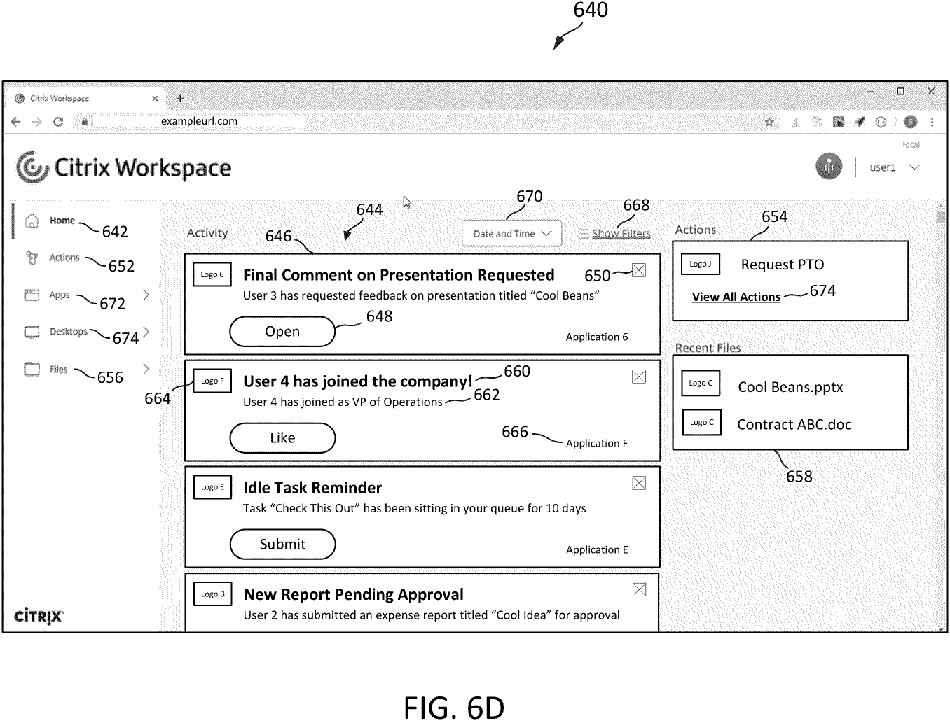

In some embodiments, a user may access the applications using a remote access application, and the applications may be provided as SaaS applications 608 shown in FIGS. 6A-6C, as described in Section F. The system may extract keywords from user interactions with the SaaS applications 608 to determine keywords.

In some embodiments, the system may additionally determine whether a selected file for sharing is related to the user’s current actions or activities (e.g., work content). If the selected file is not related to the user’s activities, then the system may cause display of a notification indicating so. Such a notification may prevent the user from sharing the wrong or unrelated file. In some implementations, the system may enable the user to dismiss the notification, and still share the selected file, if desired.

As used herein, “work-related” may refer to various items that the user may work with on a regular basis and/or in the more recent time period. Although some examples herein describe identifying work-related files based on a user’s interactions and communications in a work/employment environment, similar methods and systems can be used to identify files related to other subject matters or topics. For example, the present disclosure may be used to identify files related to school work/projects. As another example, the present disclosure may be used to identify files related to housekeeping projects (e.g., taxes, bills, budget, renovation project, meal planning, recipes, etc.).

The techniques of the present disclosure can improve user experience and efficiency in locating relevant files. Additionally, the techniques may reduce sharing of wrong/ unrelated files.

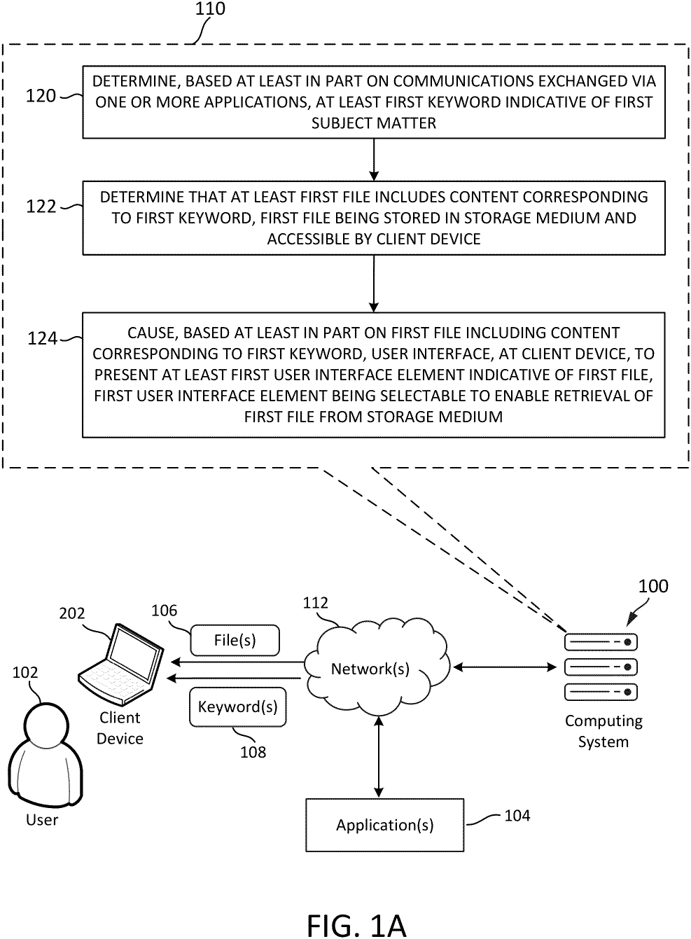

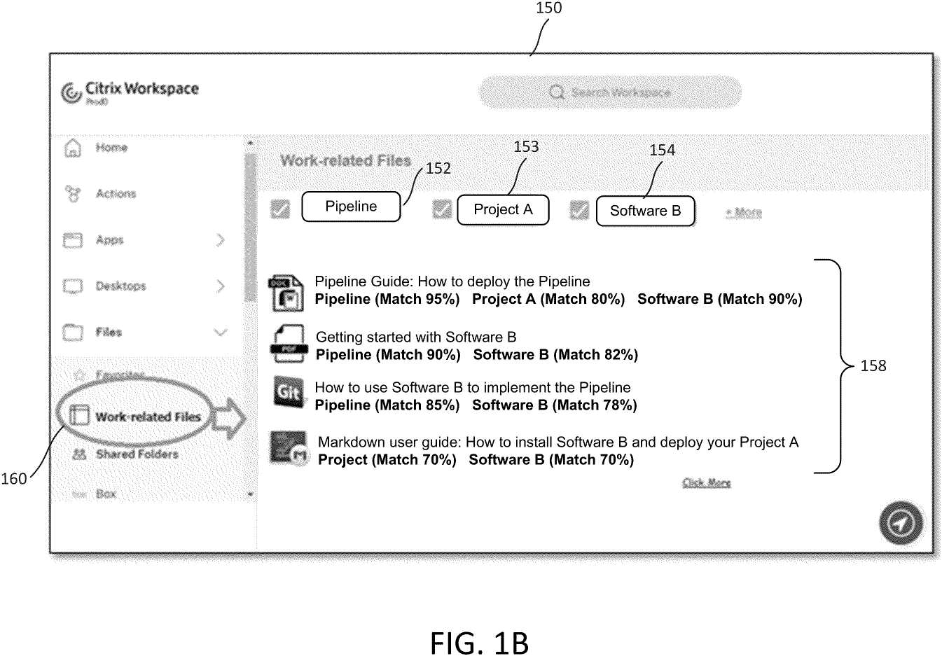

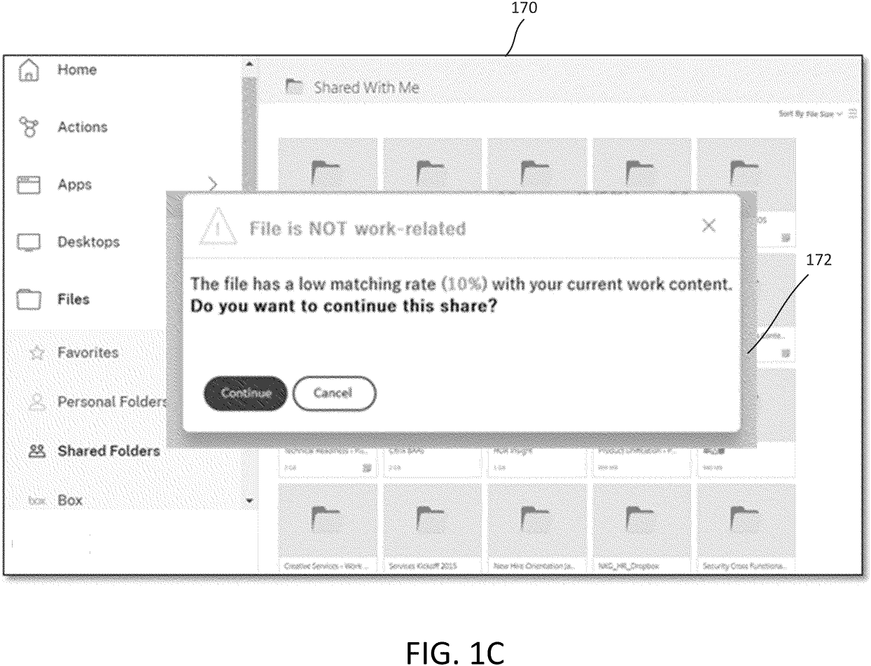

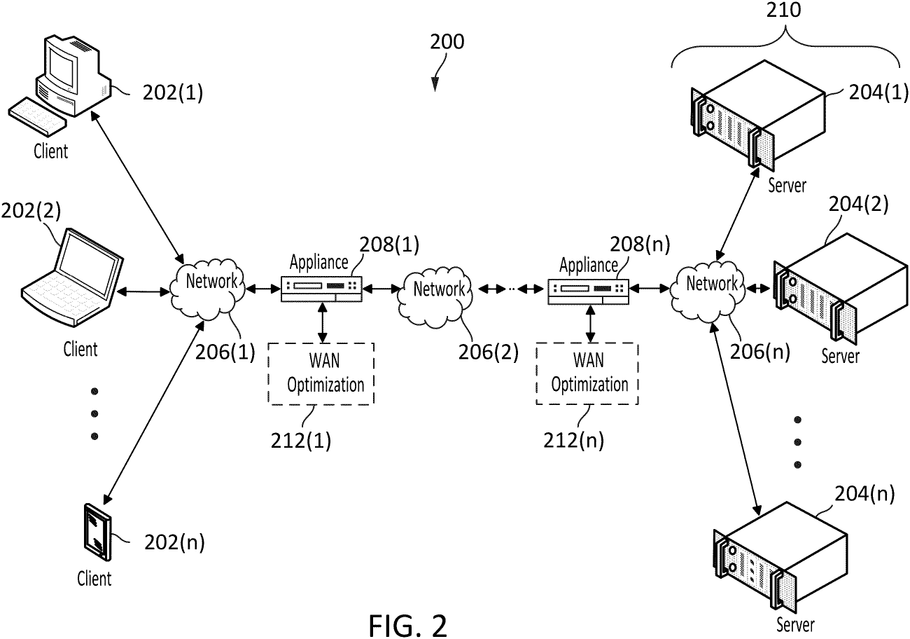

FIG. 1A is a high-level diagram illustrating how a computing system 100 may identify files in accordance with some embodiments of the present disclosure. In some embodiments, the computing system 100 may, for example, be part of the multi-resource access system 600 shown in FIGS. 6A-6C. In some embodiments, the computing system 100 may be in communication with the multi-resource access system 600. In some embodiments, the computing system 100 may include one or more servers 204 (examples of which are describe below in relation to FIG. 2). A client device 202, operated by a user 102, may be in communication with the computing system 100 using one or more networks 112. An example routine 110 that may be performed by the computing system 100 is illustrated.

One or more applications 104 may be accessed via the client device 202, and actions may be performed (e.g., by the user 102) using the applications 104. Such actions, via the application(s) 104, may include exchanging communications with other users (e.g., sending emails, receiving emails, sending messages, receiving messages, posting/sending comments, receiving comments, etc.). The actions may also include opening, sharing or otherwise accessing files. In some implementations, the client device 202 may access the application(s) 104 using the network(s) 112. In some implementations, the application(s) 104 may be provided as the SaaS applications 608 (shown in FIGS. 6A-6C), which may be accessed by the user 102 via a resource access application 622 at the client device 202.

At a step 120 of the routine 110, the computing system 100 may determine, based at least in part on communications exchanged via one or more of the applications 104, at least a first keyword 108 indicative of a first subject matter. The computing system 100 may use data representing actions performed using the application(s) 104, where such data may include emails, chat/instant messages, project management information, and the like. In some implementations, the data may correspond to a particular time period, for example, a recent time period (e.g., past month, past week, etc.). The computing system 100 may extract one or more keywords 108 from the data. The keyword(s) 108 may be indicative of a subject matter of interest to the user 102.

At a step 122 of the routine 110, the computing system 100 may determine that at least a first file 106 includes content corresponding to the first keyword 108, where the first file 106 is stored in a storage medium and accessible by the client device 202. The storage medium may be a storage system 508 of the file sharing system 504 (shown in FIGS. 5A-5C). In other implementations, the storage medium may be a storage medium of the client device 202. In some implementations, the computing system 100 may be in communication with or may include the file sharing system 504. The computing system 100 may identify files that the client device 202 is authorized to access via the file sharing system 504, and may process the contents of these files. In other implementations, the computing system 100 may process contents of the files available/stored at the client device 202. The computing system 100 may determine one or more files 106 that are similar to the keyword(s) 108. As such, the file(s) 106 may relate to a subject matter of interest to the user 102.

At a step 124 of the routine 110, the computing system 100 may cause, based at least in part of the first file 106 including content corresponding to the first keyword 108, a user interface, at the client device 202, to present at least a first user interface element indicative of the first file 106, where the first user interface element is selectable to enable retrieval of the first file 106 from the storage medium. The computing system 100 may send data indicative of the file(s) 106 to the client device 202 to cause presentation of the first user interface element. Additionally, the computing system 100 may send data indicative of the keyword(s) 108 to the client device 202, which may cause the client device 202 to present additional user interface elements representing the keyword(s) 108.

FIG. 1B shows an example user interface screen 150 showing example keywords and example files matching the example keywords. As shown, a first keyword 152 may be “Pipeline”, second keyword 153 may be “Project A”, and a third keyword 154 may be “Software B”. The client device 202 may receive an input selecting a user interface element 160 (e.g., a mouse click, a keyboard input, a touchscreen input, etc.) indicative of a request to view files, which may cause the user interface screen to display the keywords 152-154, and files 158. The files 158 may correspond to the keywords 152-154. As shown, in some implementations, the user interface screen 150 may also display a matching value indicating a how similar the respective file 158 is to one or more of the keywords 152-154.

FIG. 1C shows an example user interface screen 170 displaying a notification 172 indicating that a selected file is not related to a subject matter of interest. In some implementations, as shown, the notification 172 may include a matching value indicating how similar the selected file is to one or more subject matter(s).

In this manner, the computing system 100 may identify files based on actions performed at various applications, thus enabling efficient access to files related to a subject matter of interest.

In some implementations, the computing system 100 may determine one or more recipients of a file. For example, the client device 202 may receive an input selecting the file 106 for sharing, in response to which, the computing system 100 may evaluate communications between the user 102 and other users to identify potential recipients of the file 106. The data received from the application(s) 104 may include communications between the user 102 and other users. The computing system 100 may extract one or more keywords from the communications in a similar manner as described in relation to step 120 above. Such keywords may be associated with a second user (other than the user 102) related to the communication (e.g., the communication may be an email from the user 102 to the second user; the communication may be a message from the second user to the user 102; and the like). The computing system 100 may determine one or more keywords that match the file 106 (selected for sharing), based on determining a similarity between contents of the file 106 and the keywords. The potential recipients of the file 106 may be identified as the (second) users associated with the keywords matching the file 106. The computing system 100 may cause the client device 202 to display an indication of the potential recipients to enable selection of the potential recipient to receive a copy of the file 106.

Additional details and example implementations of embodiments of the present disclosure are set forth below in Section G, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one or more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, FL, such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, FL, such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

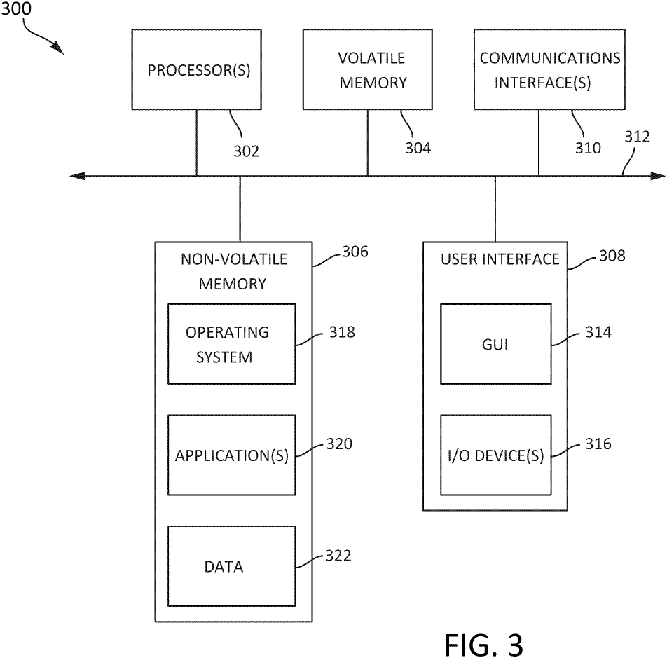

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. The volatile memory 304 and/or the non-volatile memory 306 may be one or more computer-readable mediums that are encoded with instructions to be executed by the processor(s) 302. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

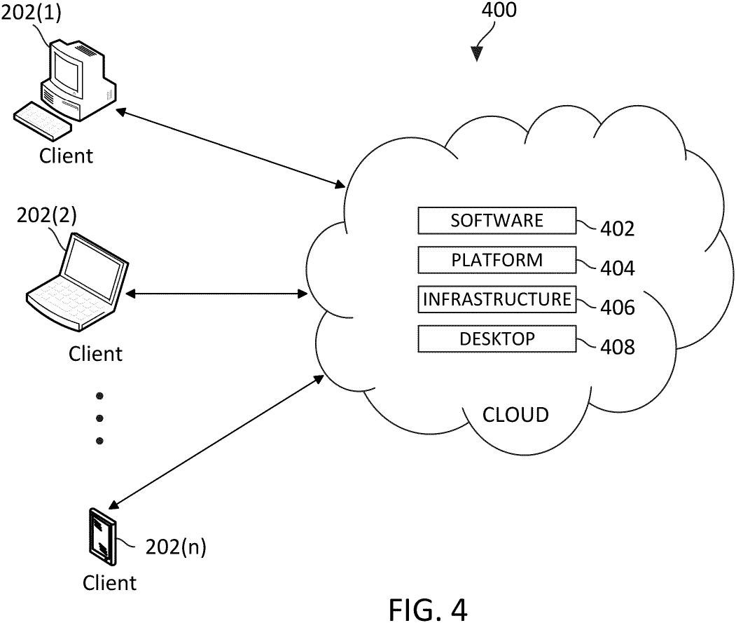

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California. Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Washington, or AMAZON WEB SERVICES provided by Amazon.com, Inc., of Seattle, Washington, for example. In the case of Citrix Cloud, Citrix Workspace app may be used as a single-entry point for bringing apps, files and desktops together (whether on-premises or in the cloud) to deliver a unified experience.

### E. Systems and Methods for Providing File Sharing Over Network(s)

FIG. 5A shows an example network environment 500 for allowing an authorized client 202 and/or an unauthorized client 202b to upload a file 502 to a file sharing system 504 or download a file 502 from the file sharing system 504. The authorized client 202 may, for example, be a client 202 operated by a user having an active account with the file sharing system 504, while the unauthorized client 202b may be operated by a user who lacks such an account. As shown, in some embodiments, the authorized client 202 may include a file management application 513 with which a user of the authorized client 202 may access and/or manage the accessibility of one or more files 502 via the file sharing system 504. The file management application 513 may, for example, be a mobile or desktop application installed on the authorized client 202 (or in a computing environment accessible by the authorized client). The ShareFile® mobile app and the ShareFile® desktop app offered by Citrix Systems, Inc., of Fort Lauderdale, FL, are examples of such preinstalled applications. In other embodiments, rather than being installed on the authorized client 202, the file management application 513 may be executed by a web server (included with the file sharing system 504 or elsewhere) and provided to the authorized client 202 via one or more web pages.

As FIG. 5A illustrates, in some embodiments, the file sharing system 504 may include an access management system 506 and a storage system 508. As shown, the access management system 506 may include one or more access management servers 204a and a database 510, and the storage system 508 may include one or more storage control servers 204b and a storage medium(s) 512. In some embodiments, the access management server(s) 204a may, for example, allow a user of the file management application 513 to log in to his or her account, e.g., by entering a user name and password corresponding to account data stored in the database 510. Once the user of the client 202 has logged in, the access management server 204a may enable the user to view (via the authorized client 202) information identifying various folders represented in the storage medium(s) 512, which is managed by the storage control server(s) 204b, as well as any files 502 contained within such folders. File/folder metadata stored in the database 510 may be used to identify the files 502 and folders in the storage medium(s) 512 to which a particular user has been provided access rights.

In some embodiments, the clients 202, 202b may be connected to one or more networks 206a (which may include the Internet), the access management server(s) 204a may include webservers, and an appliance 208a may load balance requests from the authorized client 202 to such web servers. The database 510 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202, 202b are shown is FIG. 5A as stand-alone computers, it should be appreciated that one or both of the clients 202, 202b shown in FIG. 5A may instead represent other types of computing devices or systems that can be operated by users. In some embodiments, for example, one or both of the authorized client 202 and the unauthorized client 202b may be implemented as a server-based virtual computing environment that can be remotely accessed using a separate computing device operated by users, such as described above.

In some embodiments, the access management system 506 may be logically separated from the storage system 508, such that files 502 and other data that are transferred between clients 202 and the storage system 508 do not pass through the access management system 506. Similar to the access management server(s) 204a, one or more appliances 208b may load-balance requests from the clients 202, 202b received from the network(s) 206a (which may include the Internet) to the storage control server(s) 204b. In some embodiments, the storage control server(s) 204b and/or the storage medium(s) 512 may be hosted by a cloud-based service provider (e.g., Amazon Web Services™ or Microsoft Azure™). In other embodiments, the storage control server(s) 204b and/or the storage medium(s) 512 may be located at a data center managed by an enterprise of a client 202, or may be distributed among some combination of a cloud-based system and an enterprise system, or elsewhere.

After a user of the authorized client 202 has properly logged in to an access management server 204a, the server 204a may receive a request from the client 202 for access to one of the files 502 or folders to which the logged in user has access rights. The request may either be for the authorized client 202 to itself to obtain access to a file 502 or folder or to provide such access to the unauthorized client 202b. In some embodiments, in response to receiving an access request from an authorized client 202, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 502 or folder.

In some implementations, the generated token may, for example, be sent to the authorized client 202, and the authorized client 202 may then send a request for a file 502, including the token, to the storage control server(s) 204b. In other implementations, the authorized client 202 may send the generated token to the unauthorized client 202b so as to allow the unauthorized client 202b to send a request for the file 502, including the token, to the storage control server(s) 204b. In yet other implementations, an access management server 204a may, at the direction of the authorized client 202, send the generated token directly to the unauthorized client 202b so as to allow the unauthorized client 202b to send a request for the file 502, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202 to send a request to the URL address, or by sending an email, text message or other communication including the token-containing URL to the unauthorized client 202b, either directly from the access management server(s) 204a or indirectly from the access management server(s) 204a to the authorized client 202 and then from the authorized client 202 to the unauthorized client 202b. In some embodiments, selecting the URL or a user interface element corresponding to the URL, may cause a request to be sent to the storage control server(s) 204b that either causes a file 502 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202 or an unauthorized client 202b to upload a file 502 to a folder corresponding to the token. In some embodiments, for example, an “upload” token can be generated as discussed above when an authorized client 202 is logged in and a designated folder is selected for uploading. Such a selection may, for example, cause a request to be sent to the access management server(s) 204a, and a webpage may be returned, along with the generated token, that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In some embodiments, sending a request including such a token to the storage control server(s) 204b (e.g., by selecting a URL or user-interface element included in an email inviting the user to upload one or more files 502 to the file sharing system 504), a webpage may be returned that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 5A, in some embodiments, a file sharing system may be distributed between two sub-systems, with one subsystem (e.g., the access management system 506) being responsible for controlling access to files 502 stored in the other subsystem (e.g., the storage system 508). FIG. 5B illustrates conceptually how one or more clients 202 may interact with two such subsystems.

As shown in FIG. 5B, an authorized user operating a client 202, which may take on any of numerous forms, may log in to the access management system 506, for example, by entering a valid user name and password. In some embodiments, the access management system 506 may include one or more webservers that respond to requests from the client 202. The access management system 506 may store metadata concerning the identity and arrangements of files 502 (shown in FIG. 5A) stored by the storage system 508, such as folders maintained by the storage system 508 and any files 502 contained within such folders. In some embodiments, the metadata may also include permission metadata identifying the folders and files 502 that respective users are allowed to access. Once logged in, a user may employ a user-interface mechanism of the client 202 to navigate among folders for which the metadata indicates the user has access permission.

In some embodiments, the logged-in user may select a particular file 502 the user wants to access and/or to which the logged-in user wants a different user of a different client 202 to be able to access. Upon receiving such a selection from a client 202, the access management system 506 may take steps to authorize access to the selected file 502 by the logged-in client 202 and/or the different client 202. In some embodiments, for example, the access management system 506 may interact with the storage system 508 to obtain a unique “download” token which may subsequently be used by a client 202 to retrieve the identified file 502 from the storage system 508. The access management system 506 may, for example, send the download token to the logged-in client 202 and/or a client 202 operated by a different user. In some embodiments, the download token may a single-use token that expires after its first use.

In some embodiments, the storage system 508 may also include one or more webservers and may respond to requests from clients 202. In such embodiments, one or more files 502 may be transferred from the storage system 508 to a client 202 in response to a request that includes the download token. In some embodiments, for example, the download token may be appended to a URL that resolves to an IP address of the webserver(s) of the storage system 508. Access to a given file 502 may thus, for example, be enabled by a “download link” that includes the URL/token. Such a download link may, for example, be sent the logged-in client 202 in the form of a “DOWNLOAD” button or other user-interface element the user can select to effect the transfer of the file 502 from the storage system 508 to the client 202. Alternatively, the download link may be sent to a different client 202 operated by an individual with which the logged-in user desires to share the file 502. For example, in some embodiments, the access management system 506 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 506 and cut-and-paste or otherwise copy the download link into an email or other message the logged in user can then send to the other client 202 to enable the other client 202 to retrieve the file 502 from the storage system 508.

In some embodiments, a logged-in user may select a folder on the file sharing system to which the user wants to transfer one or more files 502 (shown in FIG. 5A) from the logged-in client 202, or to which the logged-in user wants to allow a different user of a different client 202 to transfer one or more files 502. Additionally or alternatively, the logged-in user may identify one or more different users (e.g., by entering their email addresses) the logged-in user wants to be able to access one or more files 502 currently accessible to the logged-in client 202.

Similar to the file downloading process described above, upon receiving such a selection from a client 202, the access management system 506 may take steps to authorize access to the selected folder by the logged-in client 202 and/or the different client 202. In some embodiments, for example, the access management system 506 may interact with the storage system 508 to obtain a unique “upload token” which may subsequently be used by a client 202 to transfer one or more files 502 from the client 202 to the storage system 508. The access management system 506 may, for example, send the upload token to the logged-in client 202 and/or a client 202 operated by a different user.

One or more files 502 may be transferred from a client 202 to the storage system 508 in response to a request that includes the upload token. In some embodiments, for example, the upload token may be appended to a URL that resolves to an IP address of the webserver(s) of the storage system 508. For example, in some embodiments, in response to a logged-in user selecting a folder to which the user desires to transfer one or more files 502 and/or identifying one or more intended recipients of such files 502, the access management system 506 may return a webpage requesting that the user drag-and-drop or otherwise identify the file(s) 502 the user desires to transfer to the selected folder and/or a designated recipient. The returned webpage may also include an “upload link,” e.g., in the form of an “UPLOAD” button or other user-interface element that the user can select to effect the transfer of the file(s) 502 from the client 202 to the storage system 508.

In some embodiments, in response to a logged-in user selecting a folder to which the user wants to enable a different client 202 operated by a different user to transfer one or more files 502, the access management system 506 may generate an upload link that may be sent to the different client 202. For example, in some embodiments, the access management system 506 may send an email or other message to the different client 202 that includes a message indicating that the different user has been authorized to transfer one or more files 502 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 502 the different user wishes to upload to the file sharing system 504. The returned webpage may also include a user-interface element, e.g., in the form of an “UPLOAD” button, that the different user can select to effect the transfer of the file(s) 502 from the client 202 to the storage system 508. In other embodiments, the logged-in user may receive the upload link from the access management system 506 and may cut-and-paste or otherwise copy the upload link into an email or other message the logged-in user can then send to the different client 202 to enable the different client to upload one or more files 502 to the storage system 508.

In some embodiments, in response to one or more files 502 being uploaded to a folder, the storage system 508 may send a message to the access management system 506 indicating that the file(s) 502 have been successfully uploaded, and an access management system 506 may, in turn, send an email or other message to one or more users indicating the same. For user’s that have accounts with the file sharing system 504, for example, a message may be sent to the account holder that includes a download link that the account holder can select to effect the transfer of the file 502 from the storage system 508 to the client 202 operated by the account holder. Alternatively, the message to the account holder may include a link to a webpage from the access management system 506 inviting the account holder to log in to retrieve the transferred files 502. Likewise, in circumstances in which a logged-in user identifies one or more intended recipients for one or more to-be-uploaded files 502 (e.g., by entering their email addresses), the access management system 506 may send a message including a download link to the designated recipients (e.g., in the manner described above), which such designated recipients can then use to effect the transfer of the file(s) 502 from the storage system 508 to the client(s) 202 operated by those designated recipients.

FIG. 5C is a block diagram showing an example of a process for generating access tokens (e.g., the upload tokens and download tokens discussed above) within the file sharing system 504 described in connection with FIGS. 5A and 5B.

As shown, in some embodiments, a logged-in client 202 may initiate the access token generation process by sending an access request 514 to the access management server(s) 204b. As noted above, the access request 514 may, for example, correspond to one or more of (A) a request to enable the downloading of one or more files 502 (shown in FIG. 5A) from the storage system 508 to the logged-in client 202, (B) a request to enable the downloading of one or more files 502 from the storage system 508 to a different client 202 operated by a different user, (C) a request to enable the uploading of one or more files 502 from a logged-in client 202 to a folder on the storage system 508, (D) a request to enable the uploading of one or more files 502 from a different client 202 operated by a different user to a folder of the storage system 508, (E) a request to enable the transfer of one or more files 502, via the storage system 508, from a logged-in client 202 to a different client 202 operated by a different user, or (F) a request to enable the transfer of one or more files 502, via the storage system 508, from a different client 202 operated by a different user to a logged-in client 202.

In response to receiving the access request 514, an access management server 204a may send a “prepare” message 516 to the storage control server(s) 204b of the storage system 508, identifying the type of action indicated in the request, as well as the identity and/or location within the storage medium(s) 512 of any applicable folders and/or files 502. As shown, in some embodiments, a trust relationship may be established (step 518) between the storage control server(s) 204b and the access management server(s) 204a. In some embodiments, for example, the storage control server(s) 204b may establish the trust relationship by validating a hash-based message authentication code (HMAC) based on shared secret or key 530).

After the trust relationship has been established, the storage control server(s) 204b may generate and send (step 520) to the access management server(s) 204a a unique upload token and/or a unique download token, such as those as discussed above.

After the access management server(s) 204a receive a token from the storage control server(s) 204b, the access management server(s) 204a may prepare and send a link 522 including the token to one or more client(s) 202. In some embodiments, for example, the link may contain a fully qualified domain name (FQDN) of the storage control server(s) 204b, together with the token. As discussed above, the link 522 may be sent to the logged-in client 202 and/or to a different client 202 operated by a different user, depending on the operation that was indicated by the request.

The client(s) 202 that receive the token may thereafter send a request 524 (which includes the token) to the storage control server(s) 204b. In response to receiving the request, the storage control server(s) 204b may validate (step 526) the token and, if the validation is successful, the storage control server(s) 204b may interact with the client(s) 202 to effect the transfer (step 528) of the pertinent file(s) 502, as discussed above.

### F. Systems and Methods for Managing and Streamlining Access by Client Devices to a Variety of Resources

FIG. 6A is a block diagram of an example multi-resource access system 600 in which one or more resource management services 602 may manage and streamline access by one or more clients 202 to one or more resource feeds 604 (via one or more gateway services 606) and/or one or more software-as-a-service (SaaS) applications 608. In particular, the resource management service(s) 602 may employ an identity provider 610 to authenticate the identity of a user of a client 202 and, following authentication, identify one or more resources the user is authorized to access. In response to the user selecting one of the identified resources, the resource management service(s) 602 may send appropriate access credentials to the requesting client 202, and the client 202 may then use those credentials to access the selected resource. For the resource feed(s) 604, the client 202 may use the supplied credentials to access the selected resource via a gateway service 606. For the SaaS application(s) 608, the client 202 may use the credentials to access the selected application directly.

The client(s) 202 may be any type of computing devices capable of accessing the resource feed(s) 604 and/or the SaaS application(s) 608, and may, for example, include a variety of desktop or laptop computers, smartphones, tablets, etc. The resource feed(s) 604 may include any of numerous resource types and may be provided from any of numerous locations. In some embodiments, for example, the resource feed(s) 604 may include one or more systems or services for providing virtual applications and/or desktops to the client(s) 202, one or more file repositories and/or file sharing systems, one or more secure browser services, one or more access control services for the SaaS applications 608, one or more management services for local applications on the client(s) 202, one or more internet enabled devices or sensors, etc. The resource management service(s) 602, the resource feed(s) 604, the gateway service(s) 606, the SaaS application(s) 608, and the identity provider 610 may be located within an on-premises data center of an organization for which the multi-resource access system 600 is deployed, within one or more cloud computing environments, or elsewhere.

FIG. 6B is a block diagram showing an example implementation of the multi-resource access system 600 shown in FIG. 6A in which various resource management services 602 as well as a gateway service 606 are located within a cloud computing environment 612. The cloud computing environment may, for example, include Microsoft Azure Cloud, Amazon Web Services, Google Cloud, or IBM Cloud. It should be appreciated, however, that in other implementations, one or more (or all) of the components of the resource management services 602 and/or the gateway service 606 may alternatively be located outside the cloud computing environment 612, such as within a data center hosted by an organization.

For any of the illustrated components (other than the client 202) that are not based within the cloud computing environment 612, cloud connectors (not shown in FIG. 6B) may be used to interface those components with the cloud computing environment 612. Such cloud connectors may, for example, run on Windows Server instances and/or Linux Server instances hosted in resource locations and may create a reverse proxy to route traffic between those resource locations and the cloud computing environment 612. In the illustrated example, the cloud-based resource management services 602 include a client interface service 614, an identity service 616, a resource feed service 618, and a single sign-on service 620. As shown, in some embodiments, the client 202 may use a resource access application 622 to communicate with the client interface service 614 as well as to present a user interface on the client 202 that a user 624 can operate to access the resource feed(s) 604 and/or the SaaS application(s) 608. The resource access application 622 may either be installed on the client 202, or may be executed by the client interface service 614 (or elsewhere in the multi-resource access system 600) and accessed using a web browser (not shown in FIG. 6B) on the client 202.

As explained in more detail below, in some embodiments, the resource access application 622 and associated components may provide the user 624 with a personalized, all-in-one interface enabling instant and seamless access to all the user’s SaaS and web applications, files, virtual Windows applications, virtual Linux applications, desktops, mobile applications, Citrix Virtual Apps and Desktops™, local applications, and other data.

When the resource access application 622 is launched or otherwise accessed by the user 624, the client interface service 614 may send a sign-on request to the identity service 616. In some embodiments, the identity provider 610 may be located on the premises of the organization for which the multi-resource access system 600 is deployed. The identity provider 610 may, for example, correspond to an on-premises Windows Active Directory. In such embodiments, the identity provider 610 may be connected to the cloud-based identity service 616 using a cloud connector (not shown in FIG. 6B), as described above. Upon receiving a sign-on request, the identity service 616 may cause the resource access application 622 (via the client interface service 614) to prompt the user 624 for the user’s authentication credentials (e.g., username and password). Upon receiving the user’s authentication credentials, the client interface service 614 may pass the credentials along to the identity service 616, and the identity service 616 may, in turn, forward them to the identity provider 610 for authentication, for example, by comparing them against an Active Directory domain. Once the identity service 616 receives confirmation from the identity provider 610 that the user’s identity has been properly authenticated, the client interface service 614 may send a request to the resource feed service 618 for a list of subscribed resources for the user 624.

In other embodiments (not illustrated in FIG. 6B), the identity provider 610 may be a cloud-based identity service, such as a Microsoft Azure Active Directory. In such embodiments, upon receiving a sign-on request from the client interface service 614, the identity service 616 may, via the client interface service 614, cause the client 202 to be redirected to the cloud-based identity service to complete an authentication process. The cloud-based identity service may then cause the client 202 to prompt the user 624 to enter the user’s authentication credentials. Upon determining the user’s identity has been properly authenticated, the cloud-based identity service may send a message to the resource access application 622 indicating the authentication attempt was successful, and the resource access application 622 may then inform the client interface service 614 of the successfully authentication. Once the identity service 616 receives confirmation from the client interface service 614 that the user’s identity has been properly authenticated, the client interface service 614 may send a request to the resource feed service 618 for a list of subscribed resources for the user 624.

The resource feed service 618 may request identity tokens for configured resources from the single sign-on service 620. The resource feed service 618 may then pass the feed-specific identity tokens it receives to the points of authentication for the respective resource feeds 604. The resource feeds 604 may then respond with lists of resources configured for the respective identities. The resource feed service 618 may then aggregate all items from the different feeds and forward them to the client interface service 614, which may cause the resource access application 622 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 608 to which the user 624 has subscribed. The lists of local applications and the SaaS applications 608 may, for example, be supplied by resource feeds 604 for respective services that manage which such applications are to be made available to the user 624 via the resource access application 622. Examples of SaaS applications 608 that may be managed and accessed as described herein include Microsoft Office 365 applications, SAP SaaS applications, Workday applications, etc.

For resources other than local applications and the SaaS application(s) 608, upon the user 624 selecting one of the listed available resources, the resource access application 622 may cause the client interface service 614 to forward a request for the specified resource to the resource feed service 618. In response to receiving such a request, the resource feed service 618 may request an identity token for the corresponding feed from the single sign-on service 620. The resource feed service 618 may then pass the identity token received from the single sign-on service 620 to the client interface service 614 where a launch ticket for the resource may be generated and sent to the resource access application 622. Upon receiving the launch ticket, the resource access application 622 may initiate a secure session to the gateway service 606 and present the launch ticket. When the gateway service 606 is presented with the launch ticket, it may initiate a secure session to the appropriate resource feed and present the identity token to that feed to seamlessly authenticate the user 624. Once the session initializes, the client 202 may proceed to access the selected resource.

When the user 624 selects a local application, the resource access application 622 may cause the selected local application to launch on the client 202. When the user 624 selects a SaaS application 608, the resource access application 622 may cause the client interface service 614 to request a one-time uniform resource locator (URL) from the gateway service 606 as well a preferred browser for use in accessing the SaaS application 608. After the gateway service 606 returns the one-time URL and identifies the preferred browser, the client interface service 614 may pass that information along to the resource access application 622. The client 202 may then launch the identified browser and initiate a connection to the gateway service 606. The gateway service 606 may then request an assertion from the single sign-on service 620. Upon receiving the assertion, the gateway service 606 may cause the identified browser on the client 202 to be redirected to the logon page for identified SaaS application 608 and present the assertion. The SaaS may then contact the gateway service 606 to validate the assertion and authenticate the user 624. Once the user has been authenticated, communication may occur directly between the identified browser and the selected SaaS application 608, thus allowing the user 624 to use the client 202 to access the selected SaaS application 608.

In some embodiments, the preferred browser identified by the gateway service 606 may be a specialized browser embedded in the resource access application 622 (when the resource access application 622 is installed on the client 202) or provided by one of the resource feeds 604 (when the resource access application 622 is located remotely), e.g., via a secure browser service. In such embodiments, the SaaS applications 608 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 604) for assessment of its security risk by a web filtering service. For approved URLs, the specialized browser may be permitted to access the link. For suspicious links, however, the web filtering service may have the client interface service 614 send the link to a secure browser service, which may start a new virtual browser session with the client 202, and thus allow the user to access the potentially harmful linked content in a safe environment.

In some embodiments, in addition to or in lieu of providing the user 624 with a list of resources that are available to be accessed individually, as described above, the user 624 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user interface elements, e.g., “approve,” “deny,” and “see more detail” buttons, allowing a user to take one or more simple actions with respect to events right within the user’s feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 624 of something that requires the user’s attention (e.g., approval of an expense report, new course available for registration, etc.).

FIG. 6C is a block diagram similar to that shown in FIG. 6B but in which the available resources (e.g., SaaS applications, web applications, Windows applications, Linux applications, desktops, file repositories and/or file sharing systems, and other data) are represented by a single box 626 labeled “systems of record,” and further in which several different services are included within the resource management services block 602. As explained below, the services shown in FIG. 6C may enable the provision of a streamlined resource activity feed and/or notification process for a client 202. In the example shown, in addition to the client interface service 614 discussed above, the illustrated services include a microapp service 628, a data integration provider service 630, a credential wallet service 632, an active data cache service 634, an analytics service 636, and a notification service 638. In various embodiments, the services shown in FIG. 6C may be employed either in addition to or instead of the different services shown in FIG. 6B. Further, as noted above in connection with FIG. 6B, it should be appreciated that, in other implementations, one or more (or all) of the components of the resource management services 602 shown in FIG. 6C may alternatively be located outside the cloud computing environment 612, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 622 without having to launch the native application. The system shown in FIG. 6C may, for example, aggregate relevant notifications, tasks, and insights, and thereby give the user 624 a dynamic productivity tool. In some embodiments, the resource activity feed may be intelligently populated by utilizing machine learning and artificial intelligence (AI) algorithms. Further, in some implementations, microapps may be configured within the cloud computing environment 612, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 6C, the systems of record 626 may represent the applications and/or other resources the resource management services 602 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 602, and in particular the data integration provider service 630, may, for example, support REST API, JSON, OData-JSON, and XML. As explained in more detail below, the data integration provider service 630 may also write back to the systems of record, for example, using OAuth2 or a service account.

In some embodiments, the microapp service 628 may be a single-tenant service responsible for creating the microapps. The microapp service 628 may send raw events, pulled from the systems of record 626, to the analytics service 636 for processing. The microapp service may, for example, periodically pull active data from the systems of record 626.

In some embodiments, the active data cache service 634 may be single-tenant and may store all configuration information and microapp data. It may, for example, utilize a per-tenant database encryption key and per-tenant database credentials.

In some embodiments, the credential wallet service 632 may store encrypted service credentials for the systems of record 626 and user OAuth2 tokens.

In some embodiments, the data integration provider service 630 may interact with the systems of record 626 to decrypt end-user credentials and write back actions to the systems of record 626 under the identity of the end-user. The write-back actions may, for example, utilize a user’s actual account to ensure all actions performed are compliant with data policies of the application or other resource being interacted with.

In some embodiments, the analytics service 636 may process the raw events received from the microapps service 628 to create targeted scored notifications and send such notifications to the notification service 638.

Finally, in some embodiments, the notification service 638 may process any notifications it receives from the analytics service 636. In some implementations, the notification service 638 may store the notifications in a database to be later served in an activity feed. In other embodiments, the notification service 638 may additionally or alternatively send the notifications out immediately to the client 202 as a push notification to the user 624.

In some embodiments, a process for synchronizing with the systems of record 626 and generating notifications may operate as follows. The microapp service 628 may retrieve encrypted service account credentials for the systems of record 626 from the credential wallet service 632 and request a sync with the data integration provider service 630. The data integration provider service 630 may then decrypt the service account credentials and use those credentials to retrieve data from the systems of record 626. The data integration provider service 630 may then stream or otherwise provide the retrieved data to the microapp service 628. The microapp service 628 may store the received systems of record data in the active data cache service 634 and also send raw events to the analytics service 636. The analytics service 636 may create targeted scored notifications and send such notifications to the notification service 638. The notification service 638 may store the notifications in a database to be later served in an activity feed and/or may send the notifications out immediately to the client 202 as a push notification to the user 624.

In some embodiments, a process for processing a user-initiated action via a microapp may operate as follows. The client 202 may receive data from the microapp service 628 (via the client interface service 614) to render information corresponding to the microapp. The microapp service 628 may receive data from the active data cache service 634 to support that rendering. The user 624 may invoke an action from the microapp, causing the resource access application 622 to send an action request to the microapp service 628 (via the client interface service 614). The microapp service 628 may then retrieve from the credential wallet service 632 an encrypted Oauth2 token for the system of record for which the action is to be invoked, and may send the action to the data integration provider service 630 together with the encrypted OAuth2 token. The data integration provider service 630 may then decrypt the OAuth2 token and write the action to the appropriate system of record under the identity of the user 624. The data integration provider service 630 may then read back changed data from the written-to system of record and send that changed data to the microapp service 628. The microapp service 628 may then update the active data cache service 634 with the updated data and cause a message to be sent to the resource access application 622 (via the client interface service 614) notifying the user 624 that the action was successfully completed.

In some embodiments, in addition to or in lieu of the functionality described above, the resource management services 602 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 602 may enable virtual assistance functionality that allows users to remain productive and take quick actions. Users may, for example, interact with the “Virtual Assistant” and ask questions such as “What is Bob Smith’s phone number?” or “What absences are pending my approval?” The resource management services 602 may, for example, parse these requests and respond because they are integrated with multiple systems on the back-end. In some embodiments, users may be able to interact with the virtual assistant through either the resource access application 622 or directly from another resource, such as Microsoft Teams. This feature may allow employees to work efficiently, stay organized, and deliver only the specific information they’re looking for.

FIG. 6D shows how a display screen 640 presented by a resource access application 622 (shown in FIG. 6C) may appear when an intelligent activity feed feature is employed and a user is logged on to the system. Such a screen may be provided, for example, when the user clicks on or otherwise selects a “home” user interface element 642. As shown, an activity feed 644 may be presented on the screen 640 that includes a plurality of notifications 646 about respective events that occurred within various applications to which the user has access rights. An example implementation of a system capable of providing an activity feed 644 like that shown is described above in connection with FIG. 6C. As explained above, a user’s authentication credentials may be used to gain access to various systems of record (e.g., SalesForce, Ariba, Concur, RightSignature, etc.) with which the user has accounts, and events that occur within such systems of record may be evaluated to generate notifications 646 to the user concerning actions that the user can take relating to such events. As shown in FIG. 6D, in some implementations, the notifications 646 may include a title 660 and a body 662, and may also include a logo 664 and/or a name 666 of the system of record to which the notification 646 corresponds, thus helping the user understand the proper context with which to decide how best to respond to the notification 646. In some implementations, one or more filters may be used to control the types, date ranges, etc., of the notifications 646 that are presented in the activity feed 644. The filters that can be used for this purpose may be revealed, for example, by clicking on or otherwise selecting the “show filters” user interface element 668. Further, in some embodiments, a user interface element 670 may additionally or alternatively be employed to select a manner in which the notifications 646 are sorted within the activity feed. In some implementations, for example, the notifications 646 may be sorted in accordance with the “date and time” they were created (as shown for the element 670 in FIG. 6D), a “relevancy” mode (not illustrated) may be selected (e.g., using the element 670) in which the notifications may be sorted based on relevancy scores assigned to them by the analytics service 636, and/or an “application” mode (not illustrated) may be selected (e.g., using the element 670) in which the notifications 646 may be sorted by application type.

When presented with such an activity feed 644, the user may respond to the notifications 646 by clicking on or otherwise selecting a corresponding action element 648 (e.g., “Approve,” “Reject,” “Open,” “Like,” “Submit,” etc.), or else by dismissing the notification, e.g., by clicking on or otherwise selecting a “close” element 650. As explained in connection with FIG. 6C below, the notifications 646 and corresponding action elements 648 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 646 (e.g., in a separate, pop-up window corresponding to the microapp) by clicking on or otherwise selecting a portion of the notification 646 other than one of the user interface elements 648, 650. In some embodiments, the user may additionally or alternatively be able to select a user interface element either within the notification 646 or within a separate window corresponding to the microapp that allows the user to launch the native application to which the notification relates and respond to the event that prompted the notification via that native application rather than via the microapp.

In addition to the event-driven actions accessible via the action elements 648 in the notifications 646, a user may alternatively initiate microapp actions by selecting a desired action, e.g., via a drop-down menu accessible using the “action” user interface element 652 or by selecting a desired action from a list 654 of available microapp actions. In some implementations, the various microapp actions available to the user 624 logged onto the multi-resource access system 600 may be enumerated to the resource access application 622, e.g., when the user 624 initially accesses the system 600, and the list 654 may include a subset of those available microapp actions. The available microapp actions may, for example, be organized alphabetically based on the names assigned to the actions, and the list 654 may simply include the first several (e.g., the first four) microapp actions in the alphabetical order. In other implementations, the list 654 may alternatively include a subset of the available microapp actions that were most recently or most commonly accessed by the user 624, or that are preassigned by a system administrator or based on some other criteria. The user 624 may also access a complete set of available microapp actions, in a similar manner as the “action” user interface element 652, by clicking on the “view all actions” user interface element 674.

As shown, additional resources may also be accessed through the screen 640 by clicking on or otherwise selecting one or more other user interface elements that may be presented on the screen. For example, in some embodiments, the user may also access files (e.g., via a Citrix ShareFile® platform) by selecting a desired file, e.g., via a drop-down menu accessible using the “files” user interface element 656 or by selecting a desired file from a list 658 of recently and/or commonly used files. Further, in some embodiments, one or more applications may additionally or alternatively be accessible (e.g., via a Citrix Virtual Apps and Desktops™ service) by clicking on or otherwise selecting an “apps” user interface element 672 to reveal a list of accessible applications or by selecting a desired application from a list (not shown in FIG. 6D but similar to the list 658) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user interface element 674 to reveal a list of accessible desktops or by or by selecting a desired desktop from a list (not shown in FIG. 6D but similar to the list 658) of recently and/or commonly used desktops.

The activity feed shown in FIG. 6D provides significant benefits, as it allows a user to respond to application-specific events generated by disparate systems of record without needing to navigate to, launch, and interface with multiple different native applications.

### G. Detailed Description of Example Embodiments of a System for Identifying Files

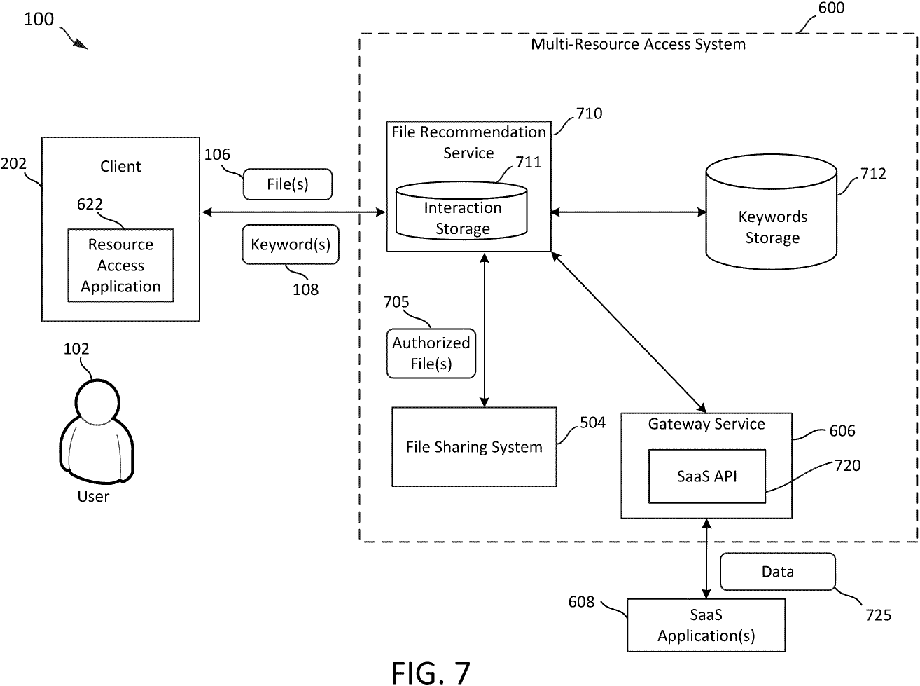

As described above in Section A, at a high level, the computing system 100 (shown in FIG. 1A) may determine keywords 108 based on actions performed at one or more applications, identify files 106 matching the keywords, and cause the client device 202 to display the matching files 106. In some implementations, the resource access application 622 may be launched at the client device 202, and may provide an input, at the resource access application 622, to view work-related files. Using the resource access application 622, one or more SaaS applications 608 (or other applications, such as one or more resource feeds 604 or local applications on the client device 202) may be accessed, which may be provided by the multi-resource access system 600 as described above in Section F. In some implementations, the multi-resource access system 600 may provide access to the file sharing system 504 (described above in Section E) via the resource access application 622 at the client device 202. In some implementations, the file sharing system 504 may be included in the multi-resource access system 600, as shown in FIG. 7. In other implementations, the file sharing system 504 may be provided as one of the SaaS applications 608.

FIG. 7 illustrates a more detailed example implementation of the computing system 100 introduced in Section A. As shown, in some implementations, the computing system 100 may include a file recommendation service 710 and a keywords storage 712, which may, for example, be included in the multi-resource access system 600. In other implementations, the file recommendation service 710 and/or the keywords storage 712 may be implemented outside of the multi-resource access system 600, and the multi-resource access system 600 may be in communication with the file recommendation service 710 and/or the keywords storage 712. In yet other implementations, the file recommendation service 710 and/or the keywords storage 712 may be implemented within the file sharing system 504. In yet other implementations, the file recommendation service 710 and/or the keywords storage 712 may be included in the client device 202 or another computing system / component.

In some implementations, the file recommendation service 710 may be embodied by one or more servers (e.g., servers 204). The file recommendation service 710 may include one or more processors (e.g., processor(s) 302) as well as one or more computer-readable mediums (e.g., volatile memory 304 and/or non-volatile memory 306) that are encoded with instructions to be executed by the processors. In some implementations, such instructions may cause the processors to implement one or more, or possibly all, of the operations of the file recommendation service 710 described herein.

The file recommendation service 710 may be configured to process interactions with one or more SaaS applications 608 (or other applications) to determine keywords for a subject matter of interest, and may identify one or more files 106 (from files 705 that the client device 202 is authorized to access using the file sharing system 504) that match the keywords 108. To process interactions with the SaaS application(s) 608, the file recommendation service 710 may be in communication with the gateway service 606 (described above in Section F). In some implementations, the gateway service 606 may include a SaaS API 720, which may enable one or more components of the multi-resource access system 600 to communicate with the SaaS application(s) 608. In some implementations, the SaaS API 720 may be included outside of the gateway service 606 as a separate component or within another component of the system 100. The file recommendation service 710 may use the SaaS API 720 to retrieve data 725, indicative of interactions, from the SaaS application(s) 608, which can be used to determine keywords. The data 725 may represent actions the user 102 may perform via the SaaS application(s) 608, where such actions may include, but are not limited to, exchanging communications with other users (e.g., sending emails, receiving emails, sending messages, receiving messages, posting/sending comments, receiving comments, etc.). The actions may also include opening, sharing or otherwise accessing files.

The keywords storage 712 may store data indicative of one or more keywords 108, which may be keywords extracted, by the file recommendation service 710, from the data 725 indicative of the interactions with SaaS application(s) 608. In some implementations, the keywords storage 712 may store an association between a keyword 108 and a matching file 106. Additionally, in some implementations, the keywords storage 712 may store a value (e.g., match value) indicating a match rate, probability of matching, matching score, etc., indicative of a likelihood of the keyword 108 matching the file 106. In some implementations, the match value may be based on a similarity (e.g., a cosine similarity) between the keyword 108, indicative of a current subject matter of interest, and the file 106. One file 106 can correspond to more than one keywords 108 and thus, the file 106 may be associated with more than one matching values.

In some implementations, the keyword 108 (and the match value) may be stored as metadata for the file 106. In some embodiments, the metadata may be stored in the file sharing system 504, for example, in the storage system 508 or the access management system 506 (described above in Section E). In other embodiments, the metadata for the file 106 may be stored in another storage or component in the file sharing system 504.

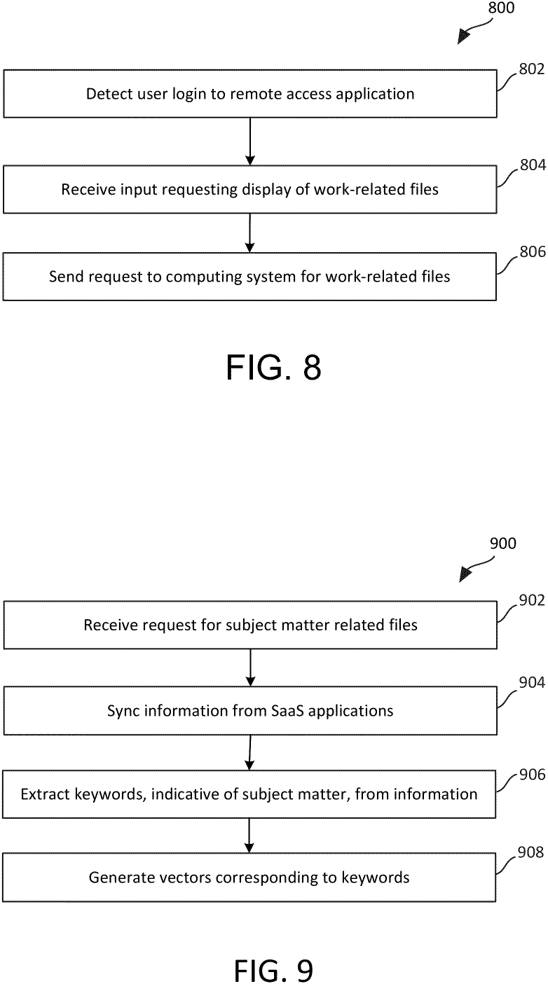

FIGS. 8-13 show example routines that may be performed by the computing system 100. Referring to FIG. 8, an example routine 800 may be performed by the resource access application 622 at the client device 202 to request display of work-related files. The resource access application 622 may be launched at the client device 202. At a step 802, the client device 202 may detect the user login to the resource access application 622. The user login may be detected based on the user 102 launching the resource access application 622 at the client device 202. The user 102 may be authenticated for the resource management services 602 (as described above in Section F) when the user 102 launches, or in some cases prior to the user 102 launching, the remote access application 622. Based on the user 102 being authenticated, the resource access application 622 may present the user interface screen 150 shown in FIG. 1B, including the selectable graphical user interface element 160. At a step 804, the resource access application 622 may receive an input requesting display of files relevant to subject matter of interest, when the element 160 is selected. In response to receipt of the input, the resource access application 622 may send, at a step 806, a request to a computing system, for example the file recommendation service 710, for relevant files.

FIG. 9 shows an example routine 900 that may be performed by the file recommendation service 710 to determine subject matter related keywords. At step 902, the file recommendation service 710 may receive a request for files, for example, from the resource access application 622 (based on the step 806 of the routine 800). In response to receiving the request, at a step 904, the file recommendation service 710 may sync information from the SaaS application(s) 608. The file recommendation service 710 may request, using the SaaS API 720, the data 725 indicative of interactions from the SaaS application(s) 608. In some implementations, the file recommendation service 710 may use separate API calls for the separate/different SaaS applications 608. For example, the file recommendation service 710 may send a first API call to retrieve data from a first SaaS application 608a (e.g., Microsoft Teams), a second API call to retrieve data from a second SaaS application 608b (e.g., Slack), a third API call to retrieve data from a third SaaS application 608c (e.g., Microsoft Outlook), and so on. The file recommendation service 710 may request the data 725 from some or all of the SaaS applications 608 that the user 102 is authorized to access via the resource access application 622. In some implementations, as described above in Section F, the resource management services 602 may be configured to use stored access credentials associated with the user 102 (or system administrator) to enable access to the SaaS application(s) 608, e.g., via one or more APIs.

In response to the API calls, the SaaS application(s) 608 may send the data indicative of interactions by the user 102 with the SaaS application(s) 608. In some implementations, the gateway service 606 may act as an intermediary between the file recommendation service 710 and the SaaS applications 608. That is, the file recommendation service 710 may send the API calls via the gateway service 606, and the file recommendation service 710 may receive the interaction data 725 via the gateway service 606.

The data 725 may be emails between the user 102 and other users, messages (e.g., instant messages, chat messages, text messages, etc.) between the user 102 and the other users, posts/comments made by the user 102, files accessed (e.g., uploaded, downloaded, modified, shared, opened, etc.) by the user 102, and the like.

The file recommendation service 710 may include an interaction storage 711 (or may be in communication with a storage) that may store the data 725. The interaction storage 711 may be refreshed/updated on a periodic basis (e.g., once a day, every other day, etc.), so that the data 725 reflects recent interactions, and thus, relate to a current subject matter of interest. The data 725 may relate to a particular time period (e.g., past month, past week, etc.). Based on receiving the data 725, the file recommendation service 710 may sync/update the information at the interaction storage 711.

At a step 906 of the routine 900, the file recommendation service 710 may extract keywords, indicative of the subject matter, from the information. The file recommendation service 710 may use one or more techniques to determine the keywords 108 from the data 725 indicative of interactions. In some implementations, for example, the file recommendation service 710 may implement one or more machine learning models to extract the keywords 108. In an example embodiment, the file recommendation service 710 may use a Latent Dirichlet Allocation (LDA) technique to derive keywords from the data 725. Another technique may involve determining a word (e.g., a noun) as being a keyword based on how often the word appears in the data 725. Yet another technique may involve topic/subject matter determination from the data 725. The file recommendation service 710 may store the keywords 108 in the keywords storage 712.

In some implementations, a machine learning model may be trained, using training data, to extract keywords. The training data may be based on a document data set including multiple different sample interactions with different SaaS applications 608. For example, the document data set may include multiple sample emails between different users, multiple sample chat messages between different users (e.g., from an instant messaging application), multiple sample posts/comments by different users within project management application, etc. In some embodiments, the document data set may be filtered to remove words that may not indicate subject matter (e.g., words like “is”, “are”, “were”, etc.). In some implementations, the document data set may be filtered to remove a predefined set of words (e.g., a stop word list), which may be defined by a system administrator. A segmentation method may be used to determine portions of the document data set for processing. In example embodiments, the segmentation method may segment the document data set based on individual sentences. In other embodiments, the segmentation method may segment the document data set based on individual words. The filtered segmented document data set may be stored and use as the training data for the machine learning model.

In some implementations, the file recommendation service 710 or another component of the multi-resource access system 600 may perform the steps to train the machine learning model. In other implementations, another computing system may perform the steps to train the machine learning model, and may provide the trained model to the file recommendation service 710 for use.

At a step 908 of the routine 900, the file recommendation service 710 may generate one or more vectors corresponding to the keywords 108. The file recommendation service 710 may, for example, use one or more techniques to determine the vectors. One technique involves using one or more machine learning models that generate a vector representation for a word (e.g., a word embedding). In some implementations, the file recommendation service 710 may use a word2vec technique that generates a 300-dimension vector for a word. The file recommendation service 710 may generate a vector for individual keywords 108, and the vectors corresponding to the keywords may be a set of vectors. In some implementations, the file recommendation service 710 may store the vectors corresponding to the keywords 108 in the keywords storage 712.

In some implementations, the file recommendation service 710 may perform the steps 904, 906 and 908 prior to receiving the request for files from the resource access application 622. The file recommendation service 710 may perform the steps 904, 906 and 908 on a periodic basis (e.g., once a day, every other data, once a week, etc.). In some implementations, the file recommendation service 710 may perform the steps 906 and 908 when the data 725 is updated, in response to, for example, the user 102 interacting with the SaaS application(s) 608.

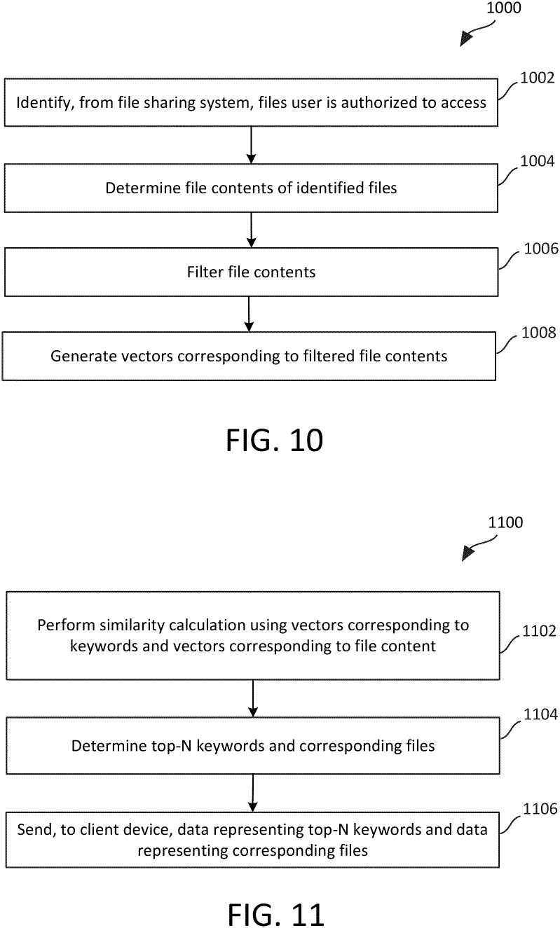

FIG. 10 shows an example routine 1000 that may be performed by the file recommendation service 710 to determine file content data. At a step 1002, the file recommendation service 710 may identify, from the file sharing system 504, files 705 that the client device 202 is authorized to access. In some implementations, the file recommendation service 710 may send a request to the file sharing system 504, and the file sharing system 504 may identify the files 705, that the client device 202 can access, based on information stored at the access management system 506 (as described above in Section E). The file sharing system 504 may provide data identifying the files 705 (e.g., filename, file identifier, folder name, etc.). In some implementations, the file sharing system 504 may also provide the files 705, from the storage system 508, to the file recommendation service 710 for processing.

At a step 1004 of the routine 1000, the file recommendation service 710 may determine content of the authorized files 705. Such determination may be based on the file recommendation service 710 receiving the authorized files 705 from the file sharing system 504. In other implementations, where the file recommendation service 710 is implemented at the file sharing system 504, the step 1004 may be performed at the storage system 508 or in conjunction with the storage system 508, without communicating or otherwise making the file contents available outside of the storage system 508.

At a step 1006 of the routine 1000, the file recommendation service 710 may filter the file contents. In some embodiments, the file contents may be filtered to remove words that may not indicate work subject matter (e.g., words like “is”, “are”, “were”, etc.). In some implementations, the file contents may be filtered to remove a set of words (e.g., a stop word list), which may be defined by a system administrator.

At a step 1008 of the routine 1000, the file recommendation service 710 may generate vector(s) corresponding to the filtered file contents. The file recommendation service 710 may use similar techniques as described above in relation to step 908 of the routine 900 to generate the vectors. The file recommendation service 710 may generate a vector for individual words in the filtered file contents. In some implementations, the file recommendation service 710 may then determine a vector based on the vectors for different the words in the sentence. The vector may be a set of vectors for the words in the sentence. The file recommendation service 710 may then determine a vector for a file based on the vectors for different sentences in the file. The vector(s) corresponding to the filtered file contents may be a set of vectors for the sentences in the file 705.

In some implementations, prior to generating the vector(s), the file recommendation service 710 may convert the file contents to text, if the file contents is not in text form already. The file recommendation service 710 may use Optical Character Recognition (OCR) or other image processing techniques to extract text from image-based file contents. If the file contents is audio or video, the file recommendation service 710 may use speech-to-text or speech recognition techniques to determine the text.

In some implementations, the file recommendation service 710 may perform the routine 1000 prior to receiving the request (at the step 902) for work-related files from the resource access application 622. The file recommendation service 710 may perform the routine 1000 on a periodic basis (e.g., once a day, every other data, once a week, etc.). In some implementations, the file recommendation service 710 may perform the routine 1000 when files 705 are updated at the file sharing system 504.

In some implementations, the file recommendation service 710 may perform the routine 1000 and steps 904-908 of the routine 900 in parallel (i.e. at substantially the same time). In some implementations, the file recommendation service 710 may precompute vectors for the keywords 108 and the file 705 contents, and may store the precomputed vectors in the keywords storage 712. The precomputed vectors may be associated with a user identifier for the user 102, and may be made accessible by the file recommendation service 710 based on the user 102 being authenticated at the resource access application 622.

FIG. 11 shows an example routine 1100 that may be performed by the file recommendation service 710 to determine files corresponding to keywords. At a step 1102 of the routine 1100, the file recommendation service 710 may calculate a similarity between the vectors corresponding to the keywords 108 and the vectors corresponding to contents of the file. The file recommendation service 710 may use one or more techniques to calculate the similarity. One technique may involve calculating a cosine similarity.

In some implementations, the file recommendation service 710 may calculate a similarity between individual keywords 108 and respective files 705. For example, the file recommendation service 710 may calculate a first similarity between the file 705a and the keyword 108a, a second similarity between the file 705a and the keyword 108b, a third similarity between the file 705b and the keyword 108a, a fourth similarity between the file 705b and the keyword 108b, and so on.

In some implementations, the file recommendation service 710 may determine matching values between individual keywords 108 and respective files 705. The matching value may be based on the cosine similarity. The matching value may indicate how similar (e.g., based on vector comparison) the file 705 is to the keyword 108 indicative of the subject matter of interest. A given file 705 may be associated with multiple matching values for the multiple corresponding keywords 108.

In some implementations, the keywords 108 and the matching files 705, along with the matching values, may be stored in the keywords storage 712. In some implementations, the matching values for the keywords 108 and corresponding files 705 may also be stored in the keywords storage 712.

At a step 1104 of the routine 1100, the file recommendation service 710 may determine top-N keywords 108 and corresponding files 106. The file recommendation service 710 may determine the top-N keywords 108 to include the keywords that have matching values that satisfy a condition (e.g., exceed a threshold). For example, the top-N keywords 108 may be keywords that have a matching value of at least “70%” with at least one file 705. In some implementations, the top-N keywords 108 may include keywords that have the most number of matching files 705. For example, the top-N keywords 108 may include a first keyword that matches at least ten of the files 705. In some implementations, the value of N may be configurable by the user 102 and/or the system administrator. For example, N may be three, and thus the top three keywords 108 may be displayed (per the next step of the routine 1100). Using the top-N keywords 108, the file recommendation service 710 may determine the corresponding files 106 from the files 705. The files 106 may be files that match the most number of the top-N keywords 108 or match a minimum number of top-N keywords 108.

At a step 1106 of the routine 1100, the file recommendation service 710 may send, to the client device 202, data representing the top-N keywords 108 and data representing the corresponding files 106. Sending of the data may cause the resource access application 622 at the client device 202 to display the user interface screen 150 shown in FIG. 1B.

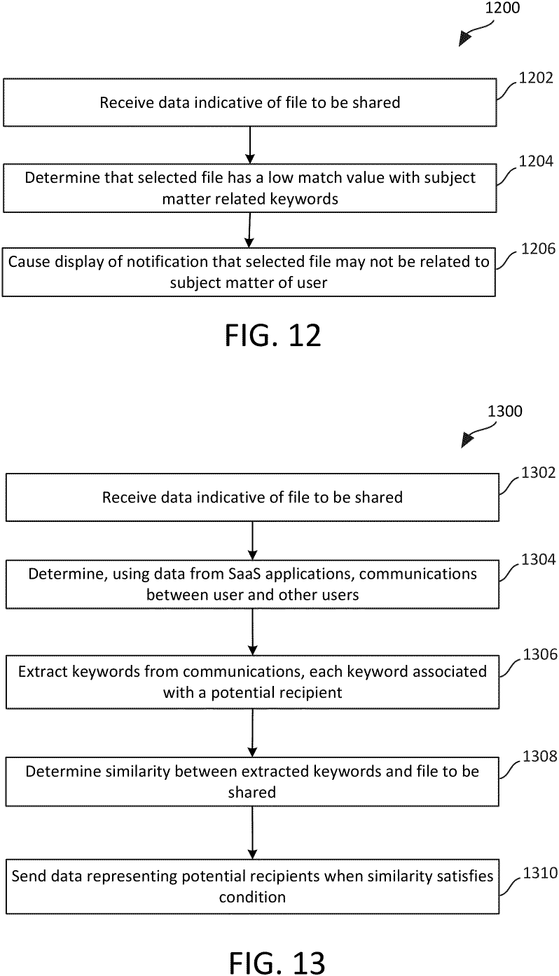

FIG. 12 shows an example routine 1200 that may be performed by the file recommendation service 710 to notify that a selected file for sharing is not work-related. At a step 1202 of the routine 1200, the file recommendation service 710 may receive data indicative of a file to be shared. Within the resource access application 622, a file (e.g., a file that is not displayed as a work-related file) may be selected (e.g., via a mouse click, a keyboard input, a touchscreen input, etc.) to share with one or more other users. Based on the selection, the resource access application 622 may send, to the file recommendation service 710, the data indicative of the file to be shared.

At a step 1204 of the routine 1200, the file recommendation service 710 may determine that the selected file has a low match value with one or more of the subject matter related keywords 108. To make this determination, the file recommendation service 710 may retrieve one or more matching values associated with the selected file. The matching values may be stored in the keywords storage 712 or as metadata for the file in the file sharing system 504. The file recommendation service 710 may determine that the selected file has a low match value with the keywords 108 based on the matching value for the selected file satisfying a condition (e.g., being below a threshold value).

At a step 1206 of the routine 1200, the file recommendation service 710 may cause display of the notification 172 (shown in FIG. 1C) that the selected file may not be related to a subject matter (e.g., of current interest). The notification 172 may be displayed at the client device 202 via the resource access application 622. Based on the notification 172, the user 102 may decide to select another file to share. Thus, the notification 172 can help a user in sharing the appropriate file. Alternatively, the user 102 may dismiss the notification 172 (e.g., by selecting “Cancel”, “Proceed Anyways”, or the like), and may choose to share the selected file. In other implementations, the file recommendation service 710 may cause the resource access application 622 to output additional or alternative types of indications (e.g., an icon, a sound, a pop-up window, etc.).

FIG. 13 shows an example routine 1300 that may be performed by the file recommendation service 710 to identify potential recipients for a file. At a step 1302 of the routine 1300, the file recommendation service 710 may receive data indicative of a file to be shared. Within the resource access application 622, a file (e.g., a file shown in the user interface screen 150 shown in FIG. 1B) may be selected to share with one or more other users. Based on the selection, the resource access application 622 may send, to the file recommendation service 710, the data indicative of the file to be shared.

At a step 1304 of the routine 1300, the file recommendation service 710 may determine, using the data 725 from the SaaS application(s) 608, communications between the user 102 and other users. The file recommendation service 710 may request the data 725 from the SaaS application(s) 608 in response to receiving (at the step 1302) the data indicative of the file to be shared. In other implementations, the file recommendation service 710 may use the data 725 previously stored in the interaction storage 711 at the file recommendation service 710.

At a step 1306 of the routine 1300, the file recommendation service 710 may extract keywords from the communications, where individual keywords are associated with respective potential recipients. The file recommendation service 710 may use one or more techniques to extract the keywords. Some techniques may involve use of one or more machine learning models. In an example embodiment, the file recommendation service 710 may use an LDA technique to extract the keywords from the interaction data 725. In addition to extracting the keyword, the file recommendation service 710 may also determine a recipient name from the communications to whom the keyword relates. For example, the file recommendation service 710 may process a chat exchange between the user 102 and another user, may determine a first keyword relating to the chat exchange, may determine the other user as a first recipient name, and may associate the first keyword with the first recipient name. In other implementations, the file recommendation service 710 may determine an identifier (e.g., an email address, a chat handle, a username, etc.) for the recipient name, and may associate the keyword to the identifier. The file recommendation service 710 may determine a list of keywords and associated recipient names/identifiers.

At a step 1308 of the routine 1300, the file recommendation service 710 may determine a similarity between the extracted keywords and the file to be shared. In some implementations, the file recommendation service 710 may determine vectors for individual extracted keywords, and vectors for contents of the file to be shared. The vectors for the extracted keywords may be determined in a similar manner as described above in relation to the step 908 of the routine 900. The vectors for the file contents may be determined in a similar manner as described above in relation to step 1008 of the routine 1000. The file recommendation service 710 may determine the similarity based on the vectors for an individual keyword and the file, and may use similar techniques as described above in relation to the step 1102 of the routine 1100. In determining the similarity, in some implementations, the file recommendation service 710 may determine a matching value (e.g., a score or a probability) representing how similar the file is to the keyword.

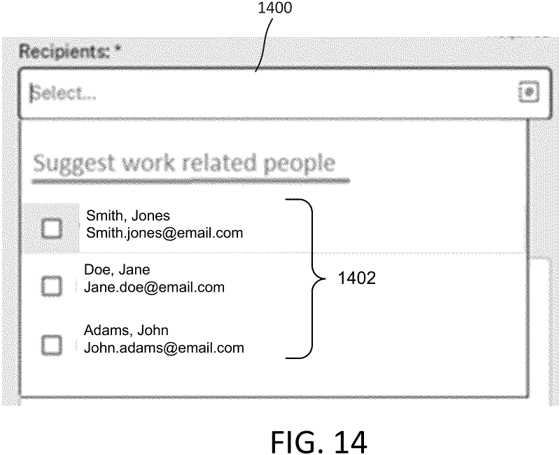

At a step 1310 of the routine 1300, the file recommendation service 710 may send data, for example to the client device, 202 representing potential recipients when the similarity satisfies a condition (e.g., exceeds a threshold). The file recommendation service 710 may determine one or more keywords that match the file based on the similarity between the keywords and the file satisfying the condition. The file recommendation service 710 may determine the potential recipients as the recipient names associated with the matching keywords. Sending of the data may cause the client device 202 to display the potential recipients, within the resource access application 622, for the file to be shared, for example, as shown in FIG. 14. In some implementations, the data, sent to the client device 202, may also or instead include identifiers for the potential recipients, and the client device 202 may display the identifiers.

In some implementations, the file recommendation service 710 may store the potential recipients (e.g., recipient names and/or identifiers for the recipients) as metadata for the file in the file sharing system 504. In other implementations, the file recommendation service 710 may associate the potential recipients with the file in the keywords storage 712.

In some implementations, the file recommendation service 710 may perform the routine 1300 and determine the potential recipients in response to the file selected for sharing (e.g., receiving the data in the step 1302). In other implementations, the file recommendation service 710 may perform the steps 1304-1310 and determine the potential recipients prior to the file being selected for sharing, for example, when the file is uploaded to the file sharing system 504, when the interaction data 725 is updated, etc.

FIG. 14 is an example user interface screen 1400 displaying potential recipients 1402. As shown, the user interface screen 1400 may display an email address for the potential recipients 1402. One or more of the potential recipients 1402 can be selected to share a file with. Other recipients can also be provided to share the file with.

In some implementations, the multi-resource access system 600 may request permission/authorization from the user 102 to process the data 725 and contents of the files 705 as described above to identify files and potential recipients. One or more of the operations described herein may be performed by the system 100 in accordance with permissions provided by the user 102 and in compliance with all appropriate laws in various jurisdictions, regulations, standards, and the like.

### H. Example Implementations of Methods, Systems, and Computer-Readable Media in Accordance with the Present Disclosure

The following paragraphs (M1) through (M10) describe examples of methods that may be implemented in accordance with the present disclosure.

(M1) A method may involve determining, by a computing system and based at least in part on communications exchanged via one or more applications, at least a first keyword indicative of a first subject matter, determining, by the computing system, that at least a first file includes content corresponding to the first keyword, the first file being stored in a storage medium and accessible by a client device, and causing, by the computing system and based at least in part on the first file including content corresponding to the first keyword, a user interface, at the client device, to present at least a first user interface element indicative of the first file, the first user interface element being selectable to enable retrieval of the first file from the storage medium.

(M2) A method may be performed as described in paragraph (M1), and may further involve receiving, by the computing system, an input from the client device, the input indicative of a request to view files stored in the storage medium and related to the first subject matter, and causing the user interface to present the first user interface element in response to receipt of the input.

(M3) A method may be performed as described in paragraph (M1) or paragraph (M2), and may further involve causing, by the computing system and based at least in part on determining the first keyword, the user interface to present a second user interface element indicative of the first keyword, the second user interface element being selectable to enable viewing of files related to the first subject matter.

(M4) A method may be performed as described in any of paragraphs (M1) through (M3), and may further involve determining, by the computing system and based at least in part on the communications exchanged with the one or more applications, at least one potential recipient of the first file, receiving, by the computing system, an input from the client device indicating that the first file is to be shared, and causing, by the computing system, the user interface to present a third user interface element indicative of the potential recipient, the third user interface element being selectable to enable sharing of the first file with the potential recipient.

(M5) A method may be performed as described in any of paragraphs (M1) through (M4), wherein determining the first keyword may further involve receiving, by the computing system from at least one other computing system, interaction data for a time period, the at least one other computing system configured to provide remote access to the one or more applications at the client device, the interaction data including at least one of: email content, messaging content and project content, and processing, by the computing system, the interaction data to determine the first keyword.

(M6) A method may be performed as described in any of paragraphs (M1) through (M5), wherein the one or more applications is at least one of: a collaboration application, a messaging application, an email application, and a project management application.

(M7) A method may be performed as described in any of paragraphs (M1) through (M6), wherein determining that the first file includes content corresponding to the first keyword may further involve identifying, by the computing system, a plurality of files, stored in the storage medium, that a user operating the client device is authorized to access using a file sharing service provided by the computing system, and determining, by the computing system and based at least in part on contents of the plurality of files, that the first file, from the plurality of files, includes content corresponding to the first keyword.

(M8) A method may be performed as described in any of paragraphs (M1) through (M7), and may further involve receiving, by the computing system, an input from the client device, the input indicating a second file, different than the first file, is to be shared, determining, by the computing system, that contents of the second file does not correspond to the first keyword, and causing, by the computing system and based at least in part on contents of the second file not corresponding to the first keyword, the user interface to present a notification that the second file is not related to the first subject matter.

(M9) A method may be performed as described in any of paragraphs (M1) through (M8), wherein identifying the first file corresponding to the first keyword may further involve determining, by the computing system, first vector data corresponding to the first keyword, determining, by the computing system, second vector data corresponding to contents of the first file, calculating, by the computing system, a similarity between the first vector data and the second vector data, and identifying, by the computing system, the first file based on the calculated similarity.

(M10) A method may be performed as described in any of paragraphs (M1) through (M9), wherein the computing system is configured to provide a remote access application at the client device so as to enable access to the one or more applications hosted at one or more remote computing systems.

The following paragraphs (S1) through (S10) describe examples of systems and devices that may be implemented in accordance with the present disclosure.

(S1) A system may comprise at least one processor and at least one computer-readable medium encoded with instructions which, when executed by the at least one processor, cause the system to determine, based at least in part on communications exchanged via one or more applications, at least a first keyword indicative of a first subject matter, determine that at least a first file includes content corresponding to the first keyword, the first file being stored in a storage medium and accessible by a client device, and cause, based at least in part on the first file including content corresponding to the first keyword, a user interface, at the client device, to present at least a first user interface element indicative of the first file, the first user interface element being selectable to enable retrieval of the first file from the storage medium.

(S2) A system may be configured as described in paragraph (S1), and the at least one computer-readable medium may be encoded with additional instructions which, when executed by the at least one processor, further cause the system to receive an input from the client device, the input indicative of a request to view files stored in the storage medium and related to the first subject matter, and cause the user interface to present the first user interface element in response to receipt of the input.

(S3) A system may be configured as described in paragraph (S1) or paragraph (S2), and the at least one computer-readable medium may be encoded with additional instructions which, when executed by the at least one processor, further cause the system to cause, based at least in part on determining the first keyword, the user interface to present a second user interface element indicative of the first keyword, the second user interface element being selectable to enable viewing of files related to the first subject matter.

(S4) A system may be configured as described in any of paragraphs (S1) through paragraph (S3), and the at least one computer-readable medium may be encoded with additional instructions which, when executed by the at least one processor, further cause the system to determine, based at least in part on the communications exchanged with the one or more applications, at least one potential recipient of the first file, receive an input from the client device indicating that the first file is to be shared, and cause the user interface to present a third user interface element indicative of the potential recipient, the third user interface element being selectable to enable sharing of the first file with the potential recipient.

(S5) A system may be configured as described in any of paragraphs (S1) through (S4), and the at least one computer-readable medium may be encoded with additional instructions which, when executed by the at least one processor, further cause the system to receive, from at least one other computing system, interaction data for a time period, the at least one other computing system configured to provide remote access to the one or more applications at the client device, the interaction data including at least one of: email content, messaging content and project content, and process the interaction data to determine the first keyword.

(S6) A system may be configured as described in any of paragraphs (S1) through (S5), wherein the one or more applications is at least one of: a collaboration application, a messaging application, an email application, and a project management application.

(S7) A system may be configured as described in any of paragraphs (S1) through (S6), and the at least one computer-readable medium may be encoded with additional instructions which, when executed by the at least one processor, further cause the system to identify a plurality of files, stored in the storage medium, that a user operating the client device is authorized to access using a file sharing service provided by the computing system, and determine, based at least in part on contents of the plurality of files, that the first file, from the plurality of files, includes content corresponding to the first keyword.

(S8) A system may be configured as described in paragraph (S7), and the at least one computer-readable medium may be encoded with additional instructions which, when executed by the at least one processor, further cause the system to receive an input from the client device, the input indicating a second file, different than the first file, is to be shared, determine that contents of the second file does not correspond to the first keyword, and cause, based at least in part on contents of the second file not corresponding to the first keyword, the user interface to present a notification that the second file is not related to the first subject matter.

(S9) A system may be configured as described in any of paragraphs (S1) through (S8), and the at least one computer-readable medium may be encoded with additional instructions which, when executed by the at least one processor, further cause the system to determine first vector data corresponding to the first keyword, determine second vector data corresponding to contents of the first file, calculate a similarity between the first vector data and the second vector data, and identify the first file based on the calculated similarity.

(S10) A system may be configured as described in any of paragraphs (S1) through (S9), wherein the system is configured to provide a remote access application at the client device so as to enable access to the one or more applications hosted at one or more remote computing systems.

The following paragraphs (CRM1) through (CRM10) describe examples of computer-readable media that may be implemented in accordance with the present disclosure.

(CRM1) At least one non-transitory computer-readable medium may be encoded with instructions which, when executed by at least one processor of a computing system, cause the computing system to determine, based at least in part on communications exchanged via one or more applications, at least a first keyword indicative of a first subject matter, determine that at least a first file includes content corresponding to the first keyword, the first file being stored in a storage medium and accessible by a client device, and cause, based at least in part on the first file including content corresponding to the first keyword, a user interface, at the client device, to present at least a first user interface element indicative of the first file, the first user interface element being selectable to enable retrieval of the first file from the storage medium.

(CRM2) At least one non-transitory computer-readable medium may be configured as described in paragraph (CRM1), and may be encoded with additional instruction which, when executed by the at least one processor, further cause the computing system to receive an input from the client device, the input indicative of a request to view files stored in the storage medium and related to the first subject matter, and cause the user interface to present the first user interface element in response to receipt of the input.

(CRM3) At least one non-transitory computer-readable medium may be configured as described in paragraph (CRM1) or paragraph (CRM2), and may be encoded with additional instruction which, when executed by the at least one processor, further cause the computing system to cause, based at least in part on determining the first keyword, the user interface to present a second user interface element indicative of the first keyword, the second user interface element being selectable to enable viewing of files related to the first subject matter.

(CRM4) At least one non-transitory computer-readable medium may be configured as described in any of paragraphs (CRM1) through (CRM3), and may be encoded with additional instruction which, when executed by the at least one processor, further cause the computing system to determine, based at least in part on the communications exchanged with the one or more applications, at least one potential recipient of the first file, receive an input from the client device indicating that the first file is to be shared, and cause the user interface to present a third user interface element indicative of the potential recipient, the third user interface element being selectable to enable sharing of the first file with the potential recipient.

(CRM5) At least one non-transitory computer-readable medium may be configured as described in any of paragraphs (CRM1) through (CRM4), and may be encoded with additional instruction which, when executed by the at least one processor, further cause the computing system to receive, from at least one other computing system, interaction data for a time period, the at least one other computing system configured to provide remote access to the one or more applications at the client device, the interaction data including at least one of: email content, messaging content and project content, and process the interaction data to determine the first keyword.

(CRM6) At least one non-transitory computer-readable medium may be configured as described in any of paragraphs (CRM1) through (CRM5), wherein the one or more applications is at least one of: a collaboration application, a messaging application, an email application, and a project management application.

(CRM7) At least one non-transitory computer-readable medium may be configured as described in any of paragraphs (CRM1) through (CRM6), and may be encoded with additional instruction which, when executed by the at least one processor, further cause the computing system to identify a plurality of files, stored in the storage medium, that a user operating the client device is authorized to access using a file sharing service provided by the computing system, and determine, based at least in part on contents of the plurality of files, that the first file, from the plurality of files, includes content corresponding to the first keyword.

(CRM8) At least one non-transitory computer-readable medium may be configured as described in any of paragraphs (CRM1) through (CRM7), and may be encoded with additional instruction which, when executed by the at least one processor, further cause the computing system to receive an input from the client device, the input indicating a second file, different than the first file, is to be shared, determine that contents of the second file does not correspond to the first keyword, and cause, based at least in part on contents of the second file not corresponding to the first keyword, the user interface to present a notification that the second file is not related to the first subject matter.

(CRM9) At least one non-transitory computer-readable medium may be configured as described in any of paragraphs (CRM1) through (CRM8), and may be encoded with additional instruction which, when executed by the at least one processor, further cause the computing system to determine first vector data corresponding to the first keyword, determine second vector data corresponding to contents of the first file, calculate a similarity between the first vector data and the second vector data, and identify the first file based on the calculated similarity.

(CRM10) At least one non-transitory computer-readable medium may be configured as described in any of paragraphs (CRM1) through (CRM9), wherein the computing system is configured to provide a remote access application at the client device so as to enable access to the one or more applications hosted at one or more remote computing systems.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method comprising:
determining, by a computing system and based at least in part on communications exchanged via one or more applications, at least a first keyword indicative of a first subject matter;
determining, by the computing system, that at least a first file includes content corresponding to the first keyword, the first file being stored in a storage medium and accessible by a client device; and
causing, by the computing system and based at least in part on the first file including content corresponding to the first keyword, a user interface, at the client device, to present at least a first user interface element indicative of the first file, the first user interface element being selectable to enable retrieval of the first file from the storage medium.

2. The method of claim 1, further comprising:
receiving, by the computing system, an input from the client device, the input indicative of a request to view files stored in the storage medium and related to the first subject matter; and
causing the user interface to present the first user interface element in response to receipt of the input.

3. The method of claim 1, further comprising:
causing, by the computing system and based at least in part on determining the first keyword, the user interface to present a second user interface element indicative of the first keyword, the second user interface element being selectable to enable viewing of files related to the first subject matter.

4. The method of claim 1, further comprising:
determining, by the computing system and based at least in part on the communications exchanged with the one or more applications, at least one potential recipient of the first file;
receiving, by the computing system, an input from the client device indicating that the first file is to be shared; and
causing, by the computing system, the user interface to present a third user interface element indicative of the potential recipient, the third user interface element being selectable to enable sharing of the first file with the potential recipient.

5. The method of claim 1, wherein determining the first keyword comprises:
receiving, by the computing system from at least one other computing system, interaction data for a time period, the at least one other computing system configured to provide remote access to the one or more applications at the client device, the interaction data including at least one of: email content, messaging content and project content; and
processing, by the computing system, the interaction data to determine the first keyword.

6. The method of claim 1, wherein the one or more applications is at least one of: a collaboration application, a messaging application, an email application, and a project management application.

7. The method of claim 1, wherein determining that the first file includes content corresponding to the first keyword comprises:
identifying, by the computing system, a plurality of files, stored in the storage medium, that a user operating the client device is authorized to access using a file sharing service provided by the computing system; and
determining, by the computing system and based at least in part on contents of the plurality of files, that the first file, from the plurality of files, includes content corresponding to the first keyword.

8. The method of claim 1, further comprising:
receiving, by the computing system, an input from the client device, the input indicating a second file, different than the first file, is to be shared;
determining, by the computing system, that contents of the second file does not correspond to the first keyword; and
causing, by the computing system and based at least in part on contents of the second file not corresponding to the first keyword, the user interface to present a notification that the second file is not related to the first subject matter.

9. The method of claim 1, wherein identifying the first file corresponding to the first keyword comprises:
determining, by the computing system, first vector data corresponding to the first keyword;
determining, by the computing system, second vector data corresponding to contents of the first file;
calculating, by the computing system, a similarity between the first vector data and the second vector data; and
identifying, by the computing system, the first file based on the calculated similarity.

10. The method of claim 1, wherein the computing system is configured to provide a remote access application at the client device so as to enable access to the one or more applications hosted at one or more remote computing systems.

11. A system comprising:
at least one processor; and
at least one computer-readable medium encoded with instructions which, when executed by the at least one processor, cause the system to:
determine, based at least in part on communications exchanged via one or more applications, at least a first keyword indicative of a first subject matter;
determine that at least a first file includes content corresponding to the first keyword, the first file being stored in a storage medium and accessible by a client device; and
cause, based at least in part on the first file including content corresponding to the first keyword, a user interface, at the client device, to present at least a first user interface element indicative of the first file, the first user interface element being selectable to enable retrieval of the first file from the storage medium.

12. The system of claim 11, wherein the at least one computer-readable medium is encoded with additional instructions which, when executed by the at least one processor, further cause the system to:
receive an input from the client device, the input indicative of a request to view files stored in the storage medium and related to the first subject matter; and
cause the user interface to present the first user interface element in response to receipt of the input.

13. The system of claim 11, wherein the at least one computer-readable medium is encoded with additional instructions which, when executed by the at least one processor, further cause the system to:
cause, based at least in part on determining the first keyword, the user interface to present a second user interface element indicative of the first keyword, the second user interface element being selectable to enable viewing of files related to the first subject matter.

14. The system of claim 11, wherein the at least one computer-readable medium is encoded with additional instructions which, when executed by the at least one processor, further cause the system to:
determine, based at least in part on the communications exchanged with the one or more applications, at least one potential recipient of the first file;
receive an input from the client device indicating that the first file is to be shared; and
cause the user interface to present a third user interface element indicative of the potential recipient, the third user interface element being selectable to enable sharing of the first file with the potential recipient.

15. The system of claim 11, wherein the at least one computer-readable medium is encoded with additional instructions which, when executed by the at least one processor, further cause the system to:
receive, from at least one other computing system, interaction data for a time period, the at least one other computing system configured to provide remote access to the one or more applications at the client device, the interaction data including at least one of: email content, messaging content and project content; and
process the interaction data to determine the first keyword.

16. The system of claim 11, wherein the one or more applications is at least one of: a collaboration application, a messaging application, an email application, and a project management application.

17. The system of claim 11, wherein the at least one computer-readable medium is encoded with additional instructions which, when executed by the at least one processor, further cause the system to:
identify a plurality of files, stored in the storage medium, that a user operating the client device is authorized to access using a file sharing service provided by the computing system; and
determine, based at least in part on contents of the plurality of files, that the first file, from the plurality of files, includes content corresponding to the first keyword.

18. The system of claim 11, wherein the at least one computer-readable medium is encoded with additional instructions which, when executed by the at least one processor, further cause the system to:
receive an input from the client device, the input indicating a second file, different than the first file, is to be shared;
determine that contents of the second file does not correspond to the first keyword; and
cause, based at least in part on contents of the second file not corresponding to the first keyword, the user interface to present a notification that the second file is not related to the first subject matter.

19. The system of claim 11, wherein the at least one computer-readable medium is encoded with additional instructions which, when executed by the at least one processor, further cause the system to:
determine first vector data corresponding to the first keyword;
determine second vector data corresponding to contents of the first file;
calculate a similarity between the first vector data and the second vector data; and
identify the first file based on the calculated similarity.

20. At least one non-transitory computer-readable medium encoded with instructions which, when executed by at least one processor of a computing system, cause the computing system to:
determine, based at least in part on communications exchanged via one or more applications, at least a first keyword indicative of a first subject matter;
determine that at least a first file includes content corresponding to the first keyword, the first file being stored in a storage medium and accessible by a client device; and
cause, based at least in part on the first file including content corresponding to the first keyword, a user interface, at the client device, to present at least a first user interface element indicative of the first file, the first user interface element being selectable to enable retrieval of the first file from the storage medium.
